(19) United States
(12) Patent Application Publication
(10) Pub. No.: US 2021/0169075 A1
(43) Pub. Date: Jun. 10, 2021

(54) ANTIBIOFILM FORMULATIONS AND METHODS FOR MICROBIAL DECONTAMINATION

(71) Applicant: Arizona Board of Regents on Behalf of Northern Arizona University, Flagstaff, AZ (US)

(72) Inventors: Andrew T. Koppisch, Flagstaff, AZ (US); Cameron Selna, Flagstaff, AZ (US); Emily K. Cope, Flagstaff, AZ (US); Nathan Christopher Nieto, Flagstaff, AZ (US); Campbell Morrissy, Flagstaff, AZ (US)

(21) Appl. No.: 17/108,956

(22) Filed: Dec. 1, 2020

Related U.S. Application Data
(60) Provisional application No. 62/944,983, filed on Dec. 6, 2019.

(51) Int. Cl. A01N 31/04; A01N 31/06; A01N 31/08

(52) U.S. Cl. CPC A01N 31/04; A01N 31/08; A01N 31/06

(57) ABSTRACT

Compositions and methods of inhibiting bacterial growth and biofilm formation on surfaces by contacting the surface with an aqueous solution of at least one compound among a terpene, terpene alcohol, and acid obtained from a plant containing such a compound. Exemplary surfaces include tubing used in beer delivery lines in a brewery/restaurant setting, and medical tubing.

### CROSS REFERENCE TO RELATED APPLICATIONS

This application claims priority to U.S. Provisional Application No. 62/944,983, filed Dec. 6, 2019, the entire content of which is incorporated herein by reference.

### TECHNICAL FIELD

The present application relates generally to formulations and methods for inhibition and prevention of microbial contamination and biofilm formation. More particularly, the application relates to the cleaning, removal of material, and prevention of material build-up and bonding, specifically that pertaining to biomaterial and biofouling, using hop extracts, or solutions of hop extract-derived compounds.

### BACKGROUND

Delivery lines are commonly used in breweries and restaurants to transfer and dispense fluids as part of beverage manufacturing and serving. Over time, these lines become contaminated by biomaterial including bacteria, mold, yeasts, among other organisms which deposit biofilms and minerals. During use, delivery lines (e.g., draught lines, dispensing system tubing) acquire a variety of surface imperfections such as scratches, pitting, or dents that become effective sites of nucleation for microbial colonization, which is a first step in the establishment of microbial biofilms, a widely recognized problem in the brewing community, as biofilms are known to contribute to off-flavors and poor head retention in beer. Often, the contaminating bacteria are lactic, butyric, or acetic acid producers, causing extreme drops in pH and strong off flavors. Common bacteria that contaminate brewing systems are lactic and acetic acid producing bacteria, including Lactobacillus spp Enterobacteriaceae, Zymomonas, Pectinatus spp and Megasphaera spp. Of these genera of bacteria, strains that are known lactic acid producers are of the most concern, particularly Lactobacillus spp.

In addition to undesirable flavors, these contaminants can also lead to continued fermentation of the product after packaging that can cause cans and bottles to leak, or even to burst. When contaminations occur, they can cause quality control problems that sometimes may only be remedied by the complete destruction of the product or the brewing hardware that housed the contamination.

Bacterial biofouling (including adhesion and colonization) of surfaces is commonly observed in both organic and inorganic environments. Microbes are remarkably capable of growing on a variety of surfaces, if provided a means to adhere and nutrients to use for growth. This adhesion and colonization of surfaces by bacteria (and other microbes) is called a biofilm. Two of the most prevalent environments at risk for biofilm contamination are food and beverage industries and hospitals/medical centers. Food and beverage products that are contaminated by bacteria and biofilms put people at risk for gastrointestinal diseases. In medical environments, biofilm infections are known to cause prolonged sickness and can also be fatal. The majority (80%) of human bacterial infections are attributable to biofilms, especially within indwelling medical devices.

Physical imperfections in surfaces can facilitate microbial adhesion or colonization. These bacterial formations may adhere to surfaces that are weathered, degraded, or cracked from use or age, particularly those that are degraded in industrial processes. In the brewing industry, plastic surfaces (including draught lines or transfer/canning lines) are frequently corrupted by microbial biofilms, likely due to the frequency with which these organisms come into contact with these surfaces and the inherent nature of the surfaces to attain physical imperfections over time.

Although many organizations have developed best practice standard operating procedures to help prevent contamination, even with the most rigorous efforts, microbial contamination still occurs frequently, typically in locations that are difficult to clean, have small moving parts or are generally not well maintained. In the brewing industry, the draught system is one of the most ideal locations for bacterial contaminations to develop. Faucets, spouts, keg couplers, and foam on beer detectors represent components that can facilitate the introduction of bacterial contaminants and the subsequent downstream contamination of draught systems.

Removal of biofilms is a priority for the brewing industry on every level: craft breweries, locally distributed craft breweries, beer distributorships and beer bars, and large-scale macrobreweries. Periodic cleaning can maintain the freshness, purity, and integrity of the beverage being served. Existing methods to managing biofouling have typically included chemical treatment, pressurized cleaning, and recirculated cleaning. Many brewers use a clean-in-place (CIP) technique wherein chemical cleaners are circulated through the lines and out the bottom drain followed by rinse cycles to remove the chemicals. Highly corrosive chemicals are also commonly used, including highly alkaline detergents (e.g., sodium hydroxide, sodium carbonate, silicates, phosphates), highly acidic cleaners (e.g., sulfuric acid, sulfamic acid, phosphoric acid, hydrogen chloride), or disinfectants (e.g., sodium hypochlorite (chlorine bleach), chlorine dioxide, iodophor, peroxyacetic acid, quaternary ammonium salts).

Detergents, cleaners, and disinfectants are selected for their ability to be neutralized and free rinsing as to not leave traces of the cleaning process which may affect the quality of the beverage produced or served. Residual chemicals pose risks to the integrity of the lines and potentially health risks to humans consuming beverages from these lines.

Other risks include those to the surrounding environment such as the water pipes and municipal water source pollution as cleaning solutions are dumped into the drain. Additionally, such chemicals may not be unduly toxic by themselves, but may combine with other organic chemicals to produce health risks to both humans and animals. Thus, there is a need for a method of cleaning delivery lines that is efficient, safe, and environmentally friendly.

### SUMMARY

Disclosed herein are systems and methods of treating a variety of surfaces, particularly plastic tubing and transfer lines commonly used in breweries or other food service industries, or medical tubing used in medical applications, such that the treated surfaces are afforded a resistance toward biofouling from microbial biofilms relative to untreated surfaces. The chemical formulations used to treat the transfer lines themselves may include one or more of (a) fermented beverages containing hop flowers as an ingredient, (b) aqueous or organic extracts of hops, and (c) aqueous or organic solutions of various terpene alcohols, esters, ethers or hydrocarbons commonly recognized as significant molecular components of hop plants and hop extracts.

Raw or purified formulations of extracted compounds from hops (Humulus lupulus) are used to pretreat/coat surfaces. This coating acts as an antibiotic and limits the extent of colonization by problematic bacteria.

Some embodiments provided herein relate to antimicrobial and/or antibiofilm formulations. In some embodiments, the formulations include an aqueous solution of at least one compound selected from the group consisting of a terpene, terpene alcohol, and acid obtained from a plant containing such a compound. In some embodiments, the plant is hops, hemp, tea, thyme, cannabis, Spanish sage, or citrus fruits. In some embodiments, the terpene is bisabolol, borneol, carene, camphene, caryophyllene, carophyllene oxide, cymene, carvacrol, eugenol, cinnamaldehyde, eucalyptol, farnesene, geraniol, geranyl acetate, humulene, linalool, linalyl isononoate, luparone, luparenol, luparol, limonene, myrcene, menthol, nerol, neral, nerolidol, ocimene, pinene, terpineol, valencene, xantholumol (including methylated, prenylated and geranylated derivatives), isoxanthohumol, myricetin, quercetin, glycosylated quercetin, kaempferol, glycosylated kaempferols, catechin, epicatechin, gallocatechin, afzelechin, epiafzelechin, procyandins B1-B4, proanthocyanidin B3, proanthocyanadine C2, or oxidized product derivatives thereof. In some embodiments, the acid is geranic acid, citronellic acid, humulone, adhumulone, posthumulone, prehumulone, cohumulone, lupulone, colupulone, adlupulone, or a combination thereof. In some embodiments, the solution contains citronellic acid and geranic acid. In some embodiments, the ratio of the citronellic and geranic acid is about 1:1. In some embodiments, the total concentration of the compound is at least about 3%. In some embodiments, the terpene, terpene alcohol, acid, or combination thereof are emulsified. In some embodiments, the aqueous solution is a buffered ethanol solution. In some embodiments, the formulations are used to pretreat a surface to resist microbial colonization. In some embodiments, the formulations do not materially alter or damage the surface. In some embodiments, the formulations leach off the surface over time. In some embodiments, microbes are removed from the surface as the formulations leach off the surface over time. In some embodiments, the surface is the surface of plastic tubing. In some embodiments, the plastic tubing is medical tubing or tubing used to carry a beverage.

Some embodiments provided herein relate to methods of inhibiting or preventing bacterial growth and/or biofilm formation on a surface. In some embodiments, the methods include contacting the surface with an aqueous solution of at least one compound of a terpene, terpene alcohol, or acid obtained from a plant containing such a compound. In some embodiments, the aqueous solution is emulsified. In some embodiments, the surface is a surface of plastic tubing. In some embodiments, the plastic tubing is medical tubing. In some embodiments, the surface is immersed in, sprayed with, or rinsed with the formulation. In some embodiments, the plant is hops, hemp, tea, thyme, cannabis, Spanish sage, or citrus fruits. In some embodiments, the terpene is bisabolol, borneol, carene, camphene, caryophyllene, carophyllene oxide, cymene, carvacrol, eugenol, cinnamaldehyde, eucalyptol, farnesene, geraniol, geranyl acetate, humulene, linalool, linalyl isononoate, luparone, luparenol, luparol, limonene, myrcene, menthol, nerol, neral, nerolidol, ocimene, pinene, terpineol, valencene, xantholumol (including methylated, prenylated and geranylated derivatives), isoxanthohumol, myricetin, quercetin, glycosylated quercetin, kaempferol, glycosylated kaempferols, catechin, epicatechin, gallocatechin, afzelechin, epiafzelechin, procyandins B1-B4, proanthocyanidin B3, proanthocyanadine C2, or oxidized product derivatives thereof. In some embodiments, the acid is geranic acid, citronellic acid, humulone, adhumulone, posthumulone, prehumulone, cohumulone, lupulone, colupulone, adlupulone, or a combination thereof. In some embodiments, the solution contains citronellic acid and geranic acid. In some embodiments, the ratio of the citronellic and geranic acid is about 1:1. In some embodiments, the total concentration of the compound is at least about 3%. In some embodiments, the aqueous solution is a buffered ethanol solution.

In some embodiments, the formulations include an extract derived from hops. In some embodiments, the extract has antimicrobial activity, suppresses microbial colonization or growth, or prevents biofilm bonding on a surface. In some embodiments, the formulations are used to pretreat the surface to resist microbial colonization. In some embodiments, the formulations do not materially alter or damage the surface. In some embodiments, the formulations leach off the surface over time. In some embodiments, the microbes are removed from the surface as the formulation leaches off the surface over time. In some embodiments, the concentration of the formulation is insufficient to contribute to a distinguishable flavor to a liquid in contact with the surface. In some embodiments, the concentration of the formulation is sufficient to contribute a flavor to the liquid in contact with the surface in a desirable manner. In some embodiments, the liquid is an alcoholic beverage, a water beverage, beer, cider, juice, or soda. In some embodiments, the surface is the surface of plastic tubing. In some embodiments, the extract includes an acid, which may be one or more of geranic acid, citronellic acid, humulone, adhumulone, posthumulone, prehumulone, cohumulone, lupulone, colupulone, adlupulone, or a combination thereof. In some embodiments, the extract includes a terpene or terpene alcohol which may be bisabolol, borneol, carene, camphene, caryophyllene, carophyllene oxide, cymene, carvacrol, eugenol, cinnamaldehyde, eucalyptol, farnesene, geraniol, geranyl acetate, humulene, linalool, linalyl isononoate, luparone, luparenol, luparol, limonene, myrcene, menthol, nerol, neral, nerolidol, ocimene, pinene, terpineol, valencene, xantholumol (including methylated, prenylated and geranylated derivatives), isoxanthohumol, myricetin, quercetin, glycosylated quercetin, kaempferol, glycosylated kaempferols, catechin, epicatechin, gallocatechin, afzelechin, epiafzelechin, procyandins B1-B4, proanthocyanidin B3, proanthocyanadine C2, or an oxidized product derivative thereof.

Some embodiments provided herein relate to methods of inhibiting bacterial growth or biofilm formation on a surface. In some embodiments, the methods include contacting the surface with an extract derived from hops. In some embodiments, the surface is a plastic surface. In some embodiments, the surface is plastic tubing. In some embodiments, the surface is a metal surface. In some embodiments, the surface is immersed in, sprayed with, or rinsed with the extract. In some embodiments, the extract includes an acid which may be one or more of geranic acid, citronellic acid, humulone, adhumulone, posthumulone, prehumulone, cohumulone, lupulone, colupulone, adlupulone, or a combination thereof. In some embodiments, the extract includes a terpene or terpene alcohol which may be bisabolol, borneol, carene, camphene, caryophyllene, carophyllene oxide, cymene, carvacrol, eugenol, cinnamaldehyde, eucalyptol, farnesene, geraniol, geranyl acetate, humulene, linalool, linalyl isononoate, luparone, luparenol, luparol, limonene, myrcene, menthol, nerol, neral, nerolidol, ocimene, pinene, terpineol, valencene, xantholumol (including methylated, prenylated and geranylated derivatives), isoxanthohumol, myricetin, quercetin, glycosylated quercetin, kaempferol, glycosylated kaempferols, catechin, epicatechin, gallocatechin, afzelechin, epiafzelechin, procyandins B1-B4, proanthocyanidin B3, proanthocyanadine C2, or an oxidized product derivative thereof.

### BRIEF DESCRIPTION OF THE DRAWINGS

The drawings described herein constitute part of this specification and includes exemplary embodiments of the present disclosure, which may be embodied in various forms. It is to be understood that in some instances, various aspects may be shown exaggerated or enlarged to facilitate an understanding of the disclosure. Therefore, drawings may not be to scale.

FIG. 1 depicts an average cell viability graph for S. aureus biofilms cultured in new (left column) and industry conditioned (right column) tubing for 24 hours. Measurements are the result of nine independent replicates (n=9 for new, n=8 for industry). A K-S test was used to determine normality in each set, a T-test was performed to determine significance. * indicates a p-value<0.05. A ** indicates a p-value<0.01. Y-axis is presented on a log scale.

FIG. 2 depicts a SEM image of new tubing at ˜1.5 k magnification, 5 kV and a working distance of 8.2 mm.

FIG. 3 depicts a SEM image of industry conditioned tubing. Physical deformations can be seen on the surface of the tubing when compared to new tubing (FIG. 2). The tubing was imaged at ˜1.8 k magnification, 5 kV and a working distance of 7.7 mm.

FIG. 4 depicts S. aureus growth in industry tubing through a series of multiple inoculations. First (n=2), second (n=2), third (n=2) and fourth (n=2) (columns from left to right) use the same two industrial tubings. After each use, the tubes were treated with aqueous (10% v/v) bleach, scrubbed and re-sterilized via autoclave. Y-axis is presented on a log scale.

FIG. 5 depicts the average cell viability graph for S. aureus growth in two sets of industry conditioned tubing. The first set of industry conditioned tubing was conditioned as shown in FIG. 3, including exposure to beer for about three months, and/or over 35,000 gallons of beer. The second set of industry conditioned tubing was exposed to beer for about 6 months, and/or exposed to about 240,000 gallons of beer. Cell densities of biofilms formed in tubing are compared to each other in first (middle column) and second (right column) sets of tubing collected from the industry as well as in new (left column) tubing demonstrating inhibition in both sets of industry conditioned tubing. A K-S test was used to determine normality in each set. n=9. A * indicates a p-value<0.05. A ** indicates a p-value<0.01. Y-axis is presented on a log scale.

FIG. 6 depicts the average cell viability graph for L. sakei cell densities of biofilms formed in new (left column) and industry conditioned (right column) tubing demonstrating inhibition in industry conditioned tubing. A K-S test was used to determine normality in each set. n=9 for new tubing. n=8 for industrially conditioned. A * indicates a p-value<0.05. A ** indicates a p-value<0.01. Y-axis is presented on a log scale.

FIG. 7 depicts the average cell viability graph for L. brevis growth in new (left column) and industry conditioned (right column) tubing demonstrating inhibition in industry conditioned tubing. A K-S test was used to determine normality in each set. n=9. A * indicates a p-value<0.05. A ** indicates a p-value<0.01. Y-axis is presented on a log scale.

FIG. 8 depicts a SEM image of biofilm formation of L. brevis grown in industry conditioned tubing. Biofilm was imaged at ˜5 k magnification, 5 kV and a working distance of 7.2 mm.

FIG. 9 depicts a SEM image of biofilm formation of L. brevis grown in new tubing. Biofilm was imaged at ˜4.3 k magnification, 5 kV and a working distance of 8.6 mm.

FIG. 10 depicts L. sakei cultured in new, beer A, beer B, and industry conditioned tubings (left to right columns, respectively). A K-S test was used to determine normality in each set. n=9 for new and beer A tubing, n=8 for beer B, n=7 for industry tubing. A * indicates a p-value<0.05 to New tubing. A ** indicates a p-value<0.01 New tubing. Y-axis is presented on a log scale.

FIG. 11 depicts L. brevis cultured in new, beer A, beer B, and industry conditioned tubings (left to right columns, respectively). A K-S test was used to determine normality in each set. n=9. A * indicates a p-value<0.05. A ** indicates a p-value<0.01. Y-axis is presented on a log scale.

FIG. 12 depicts L. sakei grown in new, industry conditioned, dry hop conditioned, beer B conditioned, and concentrated dry hop conditioned tubings (left to right columns, respectively). A K-S test was used to determine normality in each set. n=9 for new and concentrated dry hop conditioned tubing, n=8 for dry hop and beer B conditioned tubing and n=7 for industry conditioned tubing. A * indicates a p-value<0.05. A ** indicates a p-value<0.01. Y-axis is presented on a log scale.

FIG. 13 depicts L. brevis grown in new, dry hop conditioned, beer B conditioned, industry conditioned, and concentrated dry hop conditioned tubings (left to right columns, respectively). A K-S test was used to determine normality in each set. n=9. A * indicates a p-value<0.05. A ** indicates a p-value<0.01. Y-axis is presented on a log scale.

FIG. 14 is a graph depicting the pH of MRS media after conditioned with a neat mixture of geranic and citronellic acid for 24 hours. Each day represents a new 10 mL of MRS media incubated in the tubing for a 24 hour period.

FIG. 15 depicts L. brevis grown in new, tubing conditioned with a neat mixture of acids, and industry conditioned tubings (left to right columns, respectively). A K-S test was used to determine normality in each set, a T-test was performed to determine significance. * indicates a p-value<0.05. A ** indicates a p-value<0.01 Y-axis is presented on a log scale.

FIG. 16 depicts a SEM of tubing conditioned with a neat mixture of geranic and citronellic acids for 24 hours showing little to no physical damage induced by chemical contact. Tubing was imaged at ˜15 k magnification, 3 kV and a working distance of 6.9 mm.

FIG. 17 depicts tubing conditioned with neat hexane for 24 hours showing little to no physical damage induced by chemical contact. Tubing was imaged at ˜15 k magnification, 5 kV and a working distance of 6.8 mm.

FIG. 18 depicts L. brevis cultured in tubing conditioned with a dilute mixture of geranic and citronellic acid in aqueous buffer. New tubing, buffer (no acids) control conditioned tubing, and tubing conditioned with the mixture for 20 minutes, 60 minutes, and 24 hours (left to right columns, respectively). A K-S test was used to determine normality in each set. n=9. A * indicates a p-value<0.05. A ** indicates a p-value<0.01. Y-axis is presented on a log scale.

FIG. 19 depicts L. brevis cultured in tubing conditioned with a dilute mixture of acids and acids/terpenes. New tubing, buffer (no acids or terpenes) conditioned tubing, and tubing conditioned with a dilute mixture of acids for 24 hours, and a set conditioned with a dilute mixture of acids and terpenes for 24 hours (left to right columns, respectively). A K-S test was used to determine normality in each set. n=9. A * indicates a p-value<0.05. A ** indicates a p-value<0.01. Y-axis is presented on a log scale.

FIG. 20 depicts L. brevis cultured in new tubing, industry conditioned tubing, concentrated dry hop conditioned tubing, and tubing conditioned with a dilute mixture of acids and terpenes for 24 hours (left to right columns, respectively). A K-S test was used to determine normality in each set. n=9. A * indicates a p-value<0.05. A ** indicates a p-value<0.01. Y-axis is presented on a log scale.

FIG. 21 depicts Lactobacillus sakei grown in factory-new tubing, industry-conditioned tubing, concentrated dry hop-conditioned tubing, and beer B conditioned tubing (left to right columns, respectively). No growth was observed in the 10× concentrated dry hop-conditioned tubing. Significance tests were conducted against the factory-new tubing wherein * designates a P-value less than 0.05, and ** designates a P-value less than 0.001.

FIG. 22 depicts Lactobacillus brevis grown in factory-new tubing, industry-conditioned tubing, dry hop-conditioned tubing, and beer B conditioned tubing (left to right columns, respectively). Significance tests were conducted against the factory-new tubing wherein * designates a P-value less than 0.05, and ** designates a P-value less than 0.001.

FIG. 23 depicts Staphylococcus aureus grown in factory-new tubing (left column), industry-conditioned tubing (middle column—batch 1), and industry-conditioned tubing (right column—batch 2). Batch 1 tubing was used for three months and exposed to approximately 37,000 gallons of beer prior to experimental analysis. Batch 2 tubing was used for six months and exposed to approximately 240,000 gallons of beer prior to experimental analysis. Significance tests were conducted against the factory-new tubing wherein * designates a P-value less than 0.05.

FIG. 24 depicts a direct comparison of Staphylococcus aureus growth in industry-conditioned tubing (left column—batch 1) and industry-conditioned tubing (right column—batch 2). Batch 1 tubing was used for three months and exposed to approximately 37,000 gallons of beer prior to experimental analysis. Batch 2 tubing was used for six months and exposed to approximately 240,000 gallons of beer prior to experimental analysis.

FIG. 25 depicts a graph of Staphylococcus aureus grown in reused factory-new tubing. Each data point represents the average cell growth for that cycle of inoculation.

FIG. 26 depicts Lactobacillus brevis growth in tubing conditioned with neat geranic and citronellic acids, factor-new tubing, industry-conditioned tubing, and 10× concentrated dry hop-conditioned tubing (left to right columns, respectively). Significance tests were conducted against the factory-new tubing wherein * designates a P-value less than 0.05, and ** designates a P-value less than 0.001.

### DETAILED DESCRIPTION OF THE PREFERRED EMBODIMENTS

The present disclosure relates to inhibition and prevention of biofilm formation and bacterial colonization or growth on surfaces using a combination of acids and terpenes, such as raw or purified formulations of extracted compounds from hops or hop extracts to pretreat or treat the surfaces. In some embodiments, the formulations are used to pretreat or coat plastic or metal tubing and other components of beverage delivery systems, such as draught lines, which are subject to bacterial contamination and biofilm formation. In some embodiments, these formulations are used to treat surfaces of items used in the health care industry, such as medical devices or medical implants. The antimicrobial and antibiofilm formulations described herein may also be used to clean and remove bacteria and biofilms that are present on these surfaces.

Hops (Humulus lupulus), an herbaceous flowering plant relating to the hemp family, are often used as an additive for beer which imparts a bitter and aromatic flavor. Hops and hemp are known to be a rich source of natural antimicrobials including hard and soft resins, essential oils and polyphenols. Many of the compounds associated with the flavor and aroma of hops and/or hemp are isoprenoid compounds (also known as terpenoid compounds, or simply terpenes) found within the essential oils. Some of these antimicrobial compounds belong to the a and acids group (humulone and lupulone, respectively), some belong to the monoterpenes family (myrcene, limonene, pinene), some to the sesquiterpenes family (humulene, farnesene, caryophyllene), and some to the oxygenated terpenes family (linalool, geraniol, myrcenol).

Raw or purified formulations of extracted compounds from hops and/or hemp are used to pretreat or coat surfaces. This coating acts as an antibiotic and limits or prevents colonization by problematic bacteria. The chemical formulations used to treat the transfer lines may include: (a) fermented beverages such as beer containing hop flowers as an ingredient, (b) aqueous or organic extracts of hops, or (c) aqueous or organic solutions of various terpene alcohols, esters, ethers or hydrocarbons found in hop plants.

While there are many ways to sanitize plastic tubing, the formulations described herein have the advantage of being able to continuously and prophylactically sanitize and disinfect, even after they are no longer in contact with the surfaces from which they have been removed. Pretreatment serves to reduce the likelihood that surfaces, including beverage delivery lines, will become contaminated. This is advantageous over conventional disinfection techniques because it allows for continuous antibiotic action as opposed to a singular sanitation step performed on a frequent basis.

The antimicrobial formulations described herein may be used to inhibit or prevent microbial growth on any desired surface, including various forms of tubing used in the food and drink industry (e.g., lines for carbonated beverages, soda, beer, potable liquids), plastic tubing (e.g., Tygon®, vinyl, poly-vinyl chloride (PVC), polyethylene, polyurethane, polypropylene, fluoropolymers such as polytetrafluoroethylene (PTFE), perfluoroalkoxyalkane (PFA), and fluorinated ethylene propylene (FEP); silicone, thermoplastic elastomer), food-grade tubing, metal tubing, copper tubing, piping, hoses, medical tubing including catheters, surgical tubing, dialysis tubing, blood transfusion tubing, blood donation tubing, nasogastric tubes, gastric tubes, intratracheal tubes, IV tubing, medical devices, medical equipment, surgical instruments, medical implants including stents, pins, rods, dental instruments, or dental implants. It will also be appreciated that any surface subject to bacterial contamination and/or microbial biofilm formation may be pre-treated and/or treated with the antimicrobial formulations described herein.

In some embodiments, the surfaces including any surface of any tubing as disclosed herein. In some embodiments, the surface is an industry conditioned surface. As used herein, the terms “industry conditioned” have their ordinary meaning as understood in light of the specification, and refer to tubing used in a canning operation for approximately three months, and/or exposed to over 35,000 gallons of liquid, such as beer.

The surfaces to be treated may be flat, curved, ridged, smooth, or any texture capable of harnessing microbes. Some surfaces may be optically transparent, semi-transparent, opaque, or non-transparent. Some surfaces may include those that are routinely, frequently, or intermittently exposed to materials susceptible to microbial growth.

Draught and beer transfer lines may be pretreated with the formulations described herein to provide resistance to biofilm establishment and thus protect the integrity of the product (beer). In another embodiment, draught lines within a beer distributorship or beer purveyor (bar, tasting room, etc.) may be pretreated with formulations after standard line cleaning/sanitation protocols to provide resistance to biofilm development in order to protect the consistency of the product delivered to consumers. Concentrations of formulations used to treat lines are insufficient to contribute appreciable flavor profiles to the end product through leaching.

Various formulations which primarily differ in the concentration of active agent (including, for example, hops-derived acids and essential oils or hemp-derived acids and essential oils) may be used to pretreat draught lines for the purpose of leaching into the product delivered to consumers. Lines may be saturated with hop formulations, which are above the threshold determined to contribute appreciable flavor profiles to the end product. In other words, draught lines are treated with concentrations of hop products that leach from the lines as product is distributed so as to accentuate or contribute to the flavor profile of the product in a desirable way. This treatment ostensibly limits microbial corruption of the lines as well.

“Essential oils” has its ordinary meaning as understood in light of the specification, and refers to a mixture of compounds that may be derived from plants, such as hops, or that are combined to mimic a mixture derived from plants, and that include numerous different molecular species. For example, essential oils include terpene alcohols, ethers, esters, and hydrocarbons that are present in the mixture of compounds. In some embodiments, the formulations include plant derived acids and other compounds associated with plant essential oils, such as hemp- or hop-derived acids or other compounds.

The antimicrobial components of hops and antimicrobial formulations are discussed below.

### Acids

Hops contain multiple acids including α-acids which are a primary source of the bitter flavor developed in the production of beer. Exemplary α-acids include humulone, adhumulone, posthumulone, prehumulone, and cohumulone, along with their respective isomers. Additionally, β-acids are commonly found in hops which include lupulone, colupulone, and adlupulone. Acids from hemp may include, for example, tetrahydrocannabinol, tetrahydrocannabinolic acid, cannabidiol, cannabidiolic acid, cannabinol, cannabigerol, cannabichromene, cannabicyclol, cannabivarin, tetrahydrocannabivarin, tetrahydrocannabiphorol, cannabidivarin, cannabichromevarin, cannabigerovarin, cannabigerol monmethyl ether, cannabielsoin, or cannabicitran.

Other isoprenoid acids and their chemical derivatives, such as citronellic acid, citric acid, and geranic acid, may be included in the present formulations. Additional acidic compounds include cinnamic acid, gibberellic acid, isovaleric acid, butyric acid, abscisic acid, indole-3-butyric acid, salicylic acid, protocatechuic acid, abietic acid, octanoic acid, linoleic acid, oleic acid, caprylic acid, lauric acid, myristic acid, palmitic acid, palmitoleic acid, stearic acid, linoleic acid, or vanillic acid.

In some embodiments, the formulations provided herein include one or more of any of the aforementioned acids, alone or in any combination, or other acids found in hops or other plants, including tea, thyme, cannabis, Spanish sage, or citrus fruits (e.g., lemon, orange, mandarin). The acids may be present in the formulations in an amount ranging from about 0.5% w/v to about 20% w/v, such as 0.5, 1, 1.5, 2, 2.5, 3, 3.5, 4, 4.5, 5, 6, 7, 8, 9, 10, 11, 12, 13, 14, 15, 16, 17, 18, 19, or 20% w/v, or in an amount within a range defined by any two of the aforementioned values. In some embodiments, the formulations include neat (undiluted) acids in a solution ranging from about 0.5% v/v to about 20% v/v, such as 0.5, 1, 1.5, 2, 2.5, 3, 3.5, 4, 4.5, 5, 6, 7, 8, 9, 10, 11, 12, 13, 14, 15, 16, 17, 18, 19, or 20% v/v, or in an amount within a range defined by any two of the aforementioned values. In some embodiments, a combination of acids are present in a ratio ranging from about 1:10 to about 10:1, such as 1:10, 1:9, 1:8, 1:7, 1:6, 1:5, 1:4, 1:3, 1:2, 1:1, 2:1, 3:1, 4:1, 5:1, 6:1, 7:1, 8:1, 9:1 or 10:1, or at a ratio within a range defined by any two of the aforementioned values.

In some embodiments, the acids are artificially prepared in a laboratory, and isolated, purified, and added to the formulations provided herein in the appropriate quantities and ratios. In some embodiments, the acids are obtained as a purified form, including in solution or as a solid, and added to the formulations provided herein. In some embodiments, the acids are isolated from a natural sources, such as from hops, hemp, or related plant source having the acid or acids of interest. In some embodiments, the acid or combination of acids are emulsified in the formulations provided herein.

### Terpenes and Terpene Alcohols

One or more terpenes or terpene alcohols naturally found in hops or other plants including tea, thyme, cannabis, Spanish sage and citrus fruits (e.g., lemon, orange, mandarin) may be included in the antimicrobial formulations. Such compounds include, for example, bisabolol, borneol, carene, camphene, caryophyllene, carophyllene oxide, cymene, carvacrol, eugenol, cinnamaldehyde, eucalyptol, farnesene, geraniol, geranyl acetate, humulene, linalool, linalyl isononoate, luparone, luparenol, luparol, limonene, myrcene, menthol, nerol, neral, nerolidol, ocimene, pinene, terpineol, valencene, xantholumol (including methylated, prenylated and geranylated derivatives), isoxanthohumol, myricetin, quercetin (and glycosylated quercetins), kaempferol (and glycosylated kaempferols), catechin, epicatechin, gallocatechin, afzelechin, epiafzelechin, procyandins B1-B4, proanthocyanidins B3 and C2, naringenin (including methylated, prenylated and geranylated derivatives), and their oxidized product derivatives.

The terpenes or terpene alcohols may be present in the formulations in an amount ranging from about 0.5% w/v to about 20% w/v, such as 0.5, 1, 1.5, 2, 2.5, 3, 3.5, 4, 4.5, 5, 6, 7, 8, 9, 10, 11, 12, 13, 14, 15, 16, 17, 18, 19, or 20% w/v, or in an amount within a range defined by any two of the aforementioned values. In some embodiments, the formulations include terpenes or terpene alcohols in a solution ranging from about 0.5% v/v to about 20% v/v, such as 0.5, 1, 1.5, 2, 2.5, 3, 3.5, 4, 4.5, 5, 6, 7, 8, 9, 10, 11, 12, 13, 14, 15, 16, 17, 18, 19, or 20% v/v, or in an amount within a range defined by any two of the aforementioned values. In some embodiments, a combination of terpenes or terpene alcohols are present in a ratio ranging from about 1:10 to about 10:1, such as 1:10, 1:9, 1:8, 1:7, 1:6, 1:5, 1:4, 1:3, 1:2, 1:1, 2:1, 3:1, 4:1, 5:1, 6:1, 7:1, 8:1, 9:1 or 10:1, or at a ratio within a range defined by any two of the aforementioned values.

In some embodiments, the terpenes or terpene alcohols are artificially prepared in a laboratory, and isolated, purified, and added to the formulations provided herein in the appropriate quantities and ratios. In some embodiments, the terpenes or terpene alcohols are obtained as a purified form, including in solution or as a solid, and added to the formulations provided herein. In some embodiments, the terpenes or terpene alcohols are isolated from a natural sources, such as from hops, hemp, or related plant source having the terpenes or terpene alcohols of interest. In some embodiments, the terpenes or terpene alcohols are emulsified in the formulations provided herein.

Although hop, hemp, or related plant extracts themselves may be used as the antimicrobial and/or antibiofilm compositions, aqueous or organic solutions of any one or more of the hops-derived acids and/or essential oils are preferable. Hops, hemp, or related plant extraction may be performed, for example, by stirring in a buffered ethanol solution (e.g., 5% ethanol) and then filtering away the solid material.

Hops-, hemp-, or related plant-derived acids and terpenes may be used separately or in combination, and one or more of each may be present in the formulations in a total amount ranging from about 0.5% w/v to about 20% w/v, such as 0.5, 1, 1.5, 2, 2.5, 3, 3.5, 4, 4.5, 5, 6, 7, 8, 9, 10, 11, 12, 13, 14, 15, 16, 17, 18, 19, or 20% w/v, or in an amount within a range defined by any two of the aforementioned values. In some embodiments, the formulations include hops-, hemp-, or related plant-derived acids and terpenes separately or in combination in a solution ranging from about 0.5% v/v to about 20% v/v, such as 0.5, 1, 1.5, 2, 2.5, 3, 3.5, 4, 4.5, 5, 6, 7, 8, 9, 10, 11, 12, 13, 14, 15, 16, 17, 18, 19, or 20% v/v, or in an amount within a range defined by any two of the aforementioned values.

In some embodiments, antibiofilm effects are observed when the solutions are used as “neat” (undiluted) solutions down to a dilution of about 3% (v/v) of the acid and/or terpene. Thus, in some embodiments, antibiofilm activity occurs when solutions having a concentration of at least about 3% of the acid and/or terpene. In some embodiments, the solution exists as an oil-in-water emulsion at aqueous concentrations of 3% or above which may be important in the antimicrobial and/or antibiofilm effect, as dilutions of less than 3% of the acid and/or terpene are less effective, presumably due to full dissolution of the materials leading to a reduced antibiofilm effect.

In some embodiments, a combination of two acids is used. In some embodiments, the ratio of the two acids is about 1:1. Exemplary formulations include a mixture of geranic acid and citronellic acid in a 1:1 ratio which may be undiluted, or in a range of undiluted to 3% dilution in water or a buffered ethanol solution. The mixture of geranic acid and citronellic acid in a 1:1 ratio may also be combined with one or more terpenes and/or terpene alcohols (undiluted) or in a range of undiluted to 3% dilution in water or a buffered ethanol solution. In some embodiments, 17.4 grams of citronellic acid is combined with 12.2 grams of geranic acid to form an exclusively acid solution having a total acid content of about 2.96% (w:v). In some embodiments, myrcene, farnesene, linalool, and geraniol are combined in amounts of 4.09 mg, 3.38 mg, 1.59 g and 1 g, resulting in an exclusively terpene solution of about 3.2% (w:v).

In some embodiments, the formulations provided herein are prepared as an emulsion. As used herein, “emulsion” has its ordinary meaning as understood in light of the specification, and generally means any system with one liquid phase dispersed in another immiscible liquid phase, and may apply to oil-in-water and water-in-oil emulsions. Invert emulsions refer to any water-in-oil emulsion in which oil is the continuous or external phase and water is the dispersed or internal phase. Thus, in some embodiments, the formulations provided herein are emulsified. In some embodiments, emulsification of the formulations enhances or improves antibiofilm properties of the formulation. Emulsification may be achieved by any process known to generate emulsions, including, for example, intense mixing, shaking, or milling in dispersing devices.

The surface to be treated is immersed in, coated with, sprayed with, or rinsed with the antimicrobial formulations described herein. The surface may be immersed, coated, sprayed, or rinsed in the formulations provided herein for a time period ranging from about 1 second to about 24 hours, such as 1, 2, 3, 4, 5, 6, 7, 8, 9, 10, 15, 20, 25, 30, 35, 40, 45, 50, 55, or 60 seconds or 1, 2, 3, 4, 5, 6, 7, 8, 9, 10, 15, 20, 25, 30, 35, 40, 45, 50, 55, or 60 minutes or 1, 2, 3, 4, 5, 6, 7, 8, 9, 10, 12, 15, 18, 21, or 24 hours, or for a time period within a range defined by any two of the aforementioned values.

### EXAMPLES

### Example 1: Biofilm Viability Measurement

Tubing and all chemicals were purchased from Fisher Scientific. Dehydrated hop pellets, industrial tubing and beer were obtained from commercial sources. Fisherbrand™ Tygon S3™ E-3603 Flexible Tubing (Fisher Scientific #14-171-132) was purchased in 50-foot rolls for all experiments described herein. MRS broth (De Man, Rogosa, Sharpe #CM0359B) was used for all culture and manipulation of Lactobacillus species, and was purchased through Fisher Scientific. A minimum of nine sections of tubing were inoculated (n=one tubing) in the majority of experiments. After disruption of biofilm associated cells with sonication, each sample was diluted and enumerated on solid medium. The enumeration process was performed a total of three times on each disrupted sample. All data from these tests were averaged and analyzed for normality using a Kolmogorov-Smirnov test. Each set of data was normalized by ensuring that the maximum of each data point was less than 0.432 (α=0.05). After each set of data was determined to be normal, the averages of all tubings was taken and statistical significance was determined using a two tailed, unpaired Student's t-test.

Biofilm viability measurements of Lactobacillus sakei and Lactobacillus brevis (both are common contaminants associated with off-flavors and poor product in the brewing industry) established in Tygon® tubing which is commonly used in draught lines were performed. These control measurements showed biofilm formation/biofouling could be reconstituted in the laboratory environment. Scanning electron microscopic images of new and used draught lines clearly showed many more surface imperfections in used lines than new lines.

### Example 2: Stock Culture Propagation

Individual colonies of L. sakei were isolated from frozen glycerol stocks by streaking onto De Man Rogosa Sharpe (MRS) agar followed by incubation for 72 hours at 37° C. The plates were inspected for contamination indicated by the presence of variant cell morphologies (size, shape, color). A single resulting colony was used to inoculate a pilot culture (10 mL) in MRS media and was incubated with shaking (225 rpm) for 72 hours at 37° C. L. brevis was cultured in the same manner as L. sakei with the exceptions that the incubation periods on agar and in liquid media were 24 hours. Individual colonies of Methicillin-sensitive Staphylococcus aureus (MSSA) were isolated from frozen glycerol stocks within an in-house strain library by streaking onto Luria-Bertani (LB) plates followed by overnight incubation at 37° C. The following day, the plates were examined for contamination. A single colony was used to inoculate 10 mL of Cation Adjusted Mueller-Hinton Broth (CAMBH) and was incubated for 24 hours at 37° C. in an incubated shaker at 225 rpm.

### Example 3: Tubing Collection, Inoculation and Enumeration

Fifty foot rolls of tubing (Fisherbrand™ Tygon S3™ E-3603 Flexible Tubing, Fisher Scientific #14-171-132) designed for food, beverage, and dairy products were collected after three months of constant use within a brewery's canning lines. Immediately upon collection from the brewery, the tubing had recently undergone a cleaning and sanitation procedure standard in the industry. In brief, the tubing was used in the brewery for beer transfer from a carbonation tank to a canning machine to fill cans for distribution. Before each set of canning runs, the tubing was heated to at least 160 degrees for 15 minutes, followed by a 15-minute soak in a no-rinse sanitizer (peracetic acid) for 15 minutes. Beer was then used to flush sanitizer and continue proper canning procedures. After each canning run, the machine was again rinsed with hot water and brought to 160 degrees for 15 minutes followed by a soak with nitric and phosphoric acid blend for 15 minutes. Approximately 37,000 gallons of beer had been transferred through the tubing over the course of the use (approximately three months). All tubing was stored in a sealed plastic bag at 4° C. At a later date, a second batch of tubing was collected and stored in the same fashion. In this instance, the second sample had been in constant use for six months with an elevated flow relative to the first set. The second batch of tubing collected had been exposed to an estimated 240,000 gallons of beer over the course of its use. The industry conditioned PVC tubing was cut into short (17″) lengths, wrapped with aluminum foil on both ends, and sterilized via autoclave. All tubing was allowed to cool for at least 15 minutes before use. A similar procedure was adopted for sterilization of new PVC tubing and these tubing lengths were used as control materials.

### Example 4: Staphylococcus aureus Inoculation and Enumeration

A small sample (10 mL) of CAMBH was inoculated with a confluent culture of MSSA (20 μL) to afford a final inoculum of approximately 1×10⁵⁵ cells/mL. The entirety of the inoculated media was used to fill individually cut lengths of tubing, and the open ends then covered with foil. The tubes were placed upright in a static incubator and were incubated without agitation at 37° C. for 24 hours. The media was then decanted and discarded, the tubing was rinsed with sterile water (10 mL) and an additional 10 mL of CAMBH media was added to the tubing. The tubing was then sonicated in a bath sonicator for 15 minutes (power level 9). After sonication, viable bacteria were diluted (typically six serial ten-fold dilutions of the dispersed media from the tubing) and placed on solid medium. Three 15 μL drops of each dilution were placed onto LB agar and this process was repeated three times for each inoculated tubing to obtain an accurate assessment of cell density. The LB agar plates were incubated overnight in a static incubator at 37° C. The following day the individual colonies were enumerated to quantify viable cells.

### Example 5: Lactobacillus brevis Inoculation and Enumeration

A small sample (10 mL) of MRS was inoculated with a confluent culture of L. brevis (20 μL) to afford a final inoculum of approximately 1×10⁵⁵ cells/mL. The inoculated media was used to fill individually cut lengths of tubing, typically three sections of tubing, ends covered with foil and were incubated without agitation in a static incubator at 37° C. for 24 hours. The media was then discarded, the tubing was rinsed with sterile water (10 mL) and an additional 10 mL of MRS media was added to the tubing. The tubing was then sonicated in a bath sonicator for 15 minutes (power level 9). After sonication, viable bacteria were diluted (typically six serial ten-fold dilutions of the dispersed media from the tubing) and placed on solid medium in a petri dish. Three 10 μL drops of each dilution were placed onto MRS agar and this process was repeated three times for each inoculated tubing to obtain an accurate assessment of cell density. The MRS agar plates were incubated overnight in a static incubator at 37° C. The following day the individual colonies were enumerated to quantify viable cells.

Lactobacillus sakei was inoculated and enumerated in the same way as L. brevis with the exceptions that the incubation periods in tubing and on agar required 72 hours.

### Example 6: Imaging and Analysis of Microbial Contamination and Biofilm Formation

L. brevis was inoculated in De Man, Regosa, and Sharpe (MRS) media as described in Example 5, and the inoculum (10 mL) was placed into 17″ sections of the industry conditioned and factory new tubing, respectively. Inoculated tubing was placed in a static incubator for 24 hours at 37° C. Following biofilm growth, the tubing was removed, media decanted, and washed with sterile water. A small section of the tubing was cut from the center of the line, and was further divided into four equal parts to expose the inside of the tubing. All sections of tubing were submerged and fixed in a 2.0% (by volume) glutaraldehyde solution in a 0.15 M sodium cacodylate buffer at 7.2 pH for 24 hours at 4° C. After this, the glutaraldehyde solution was removed and replaced with sodium cacodylate buffer at 7.2 pH for 15 minutes. This process was repeated twice more to remove excess fixative. After the final removal of the buffer, the tubing was submerged in 1.0% osmium tetroxide solution for one hour, and then rinsed with water to remove excess fixative. Samples were dehydrated via ethanol rinses at 50%, 70%, 95% and 100% in succession for 10 minutes each. Following the dehydrating step, the samples were placed into a 1:1 mixture of hexamethyldisilazane (HDMS) and ethanol for 15 minutes, followed by two soaks of HMDS for 15 minutes. Processed samples were placed uncovered in the fume hood for 24 hours. Following the drying step, tubing was placed on stubs using double sided carbon tape and coated with a gold/palladium alloy using a Denton Vacuum Desk II for ten seconds to ensure that the small structures would remain visible. Samples were imaged on a Zeiss Supra 40VP at ˜1500× magnification and a varying power level of 3 to 5 kV.

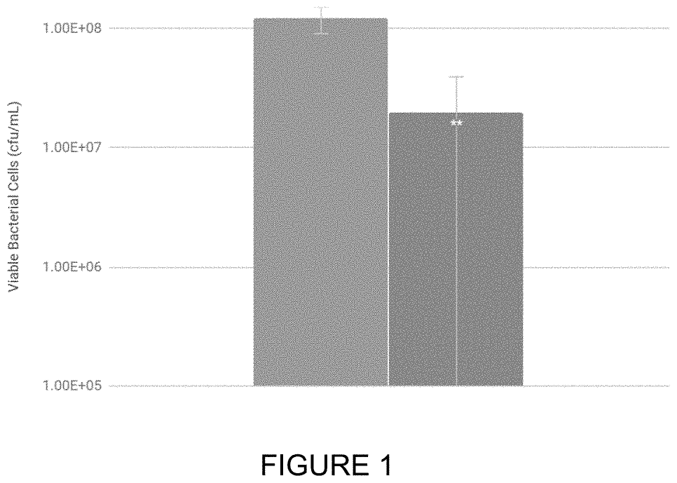

Biofilm attachment and proliferation on abiotic surfaces is generally accepted in microbiology to be facilitated by the presence of imperfections in the surface. In the context of draught lines, wear and tear associated with prolonged use ostensibly introduces imperfections in the form of cracks, scratches and deposits. It is well known that draught lines are a prevalent site of biofilm colonization in breweries, tap houses, and bars, and these induced imperfections, which accumulate in the lines with use, are presumed to be a significant reason for this observation. As such, it was reasonable to assume that used tubing would support an increased bacterial biofilm load relative to unused tubing. In order to test this hypothesis, an assay was developed to culture biofilms in common tubing. The test is a modification of the static biofilm assay commonly used in the field. In the static biofilm assay, actively proliferating bacteria are inoculated into fresh media and placed in a sterile vessel, typically a culture tube or a multiwell plate, and incubated without agitation overnight. Biofilms of various maturation may be generated by removing spent media and replenishing with fresh media, however it is well known that a single overnight incubation (e.g. 24 hours of culture) is sufficient for a robust biofilm formation for many strains. S. aureus was chosen for the initial studies because it is a well-known biofilm forming bacteria with short growth cycles (24 hours). S. aureus biofilms grown in this manner appeared to have a slightly higher average density than the average of those formed in a minimal biofilm eradication concentration assay (˜1×10⁸ vs 1×10⁷ cfu/mL, respectively) (FIG. 1).

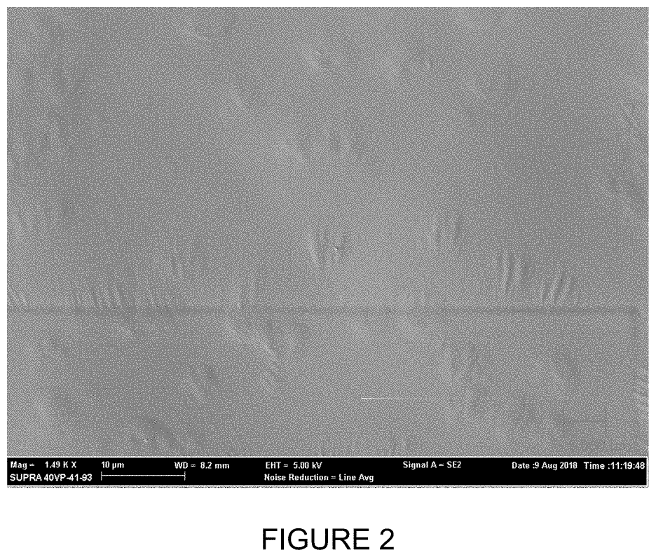

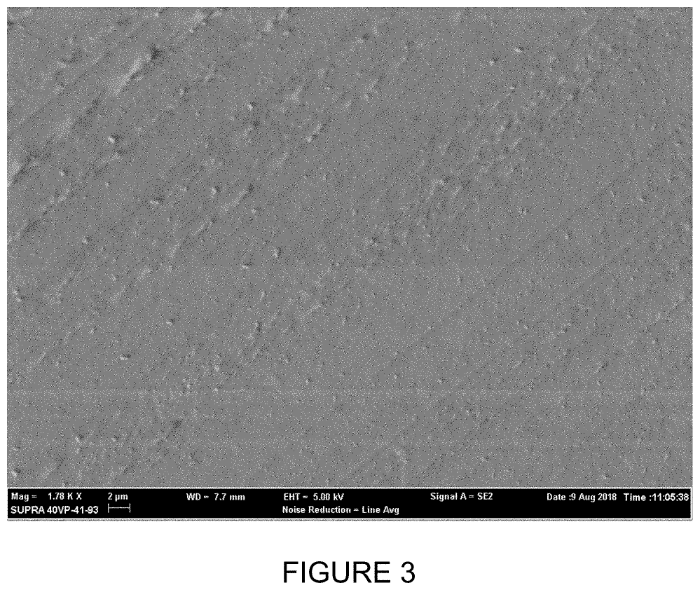

To avoid as much disruption to the biofilms formed in the tubing as possible, washing was performed once as opposed to multiple times. FIG. 1 also demonstrates a lower viable cell density of S. aureus in industry conditioned tubing (right column) relative to new (left column). SEM analysis of both new and conditioned tubing verified the presence of imperfections in the used lines. As shown in FIGS. 2 and 3, there is clear physical weathering of the tubing collected from industry (FIG. 3) when compared to new, unused tubing (FIG. 2), so the observation that bacterial growth was inhibited in conditioned lines relative to new suggested that some aspect of the conditioning had introduced an inhibitory component.

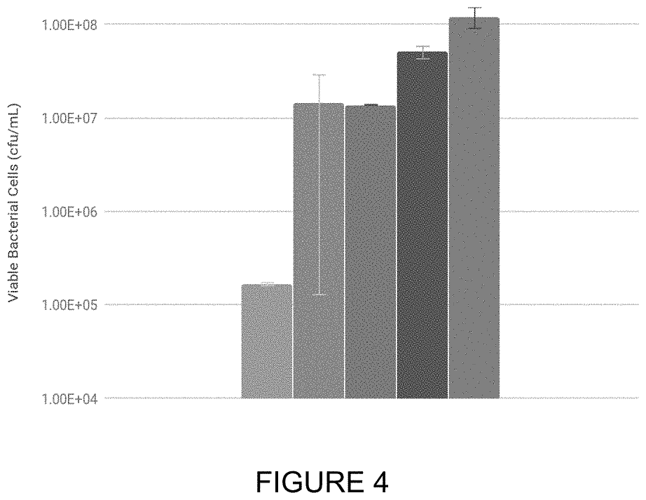

Furthermore, data acquired in a small pilot study of the reproducibility of inhibition suggested that with repeated use, biofilm colonization in conditioned lines eventually mirrored that in new tubing (FIG. 4).

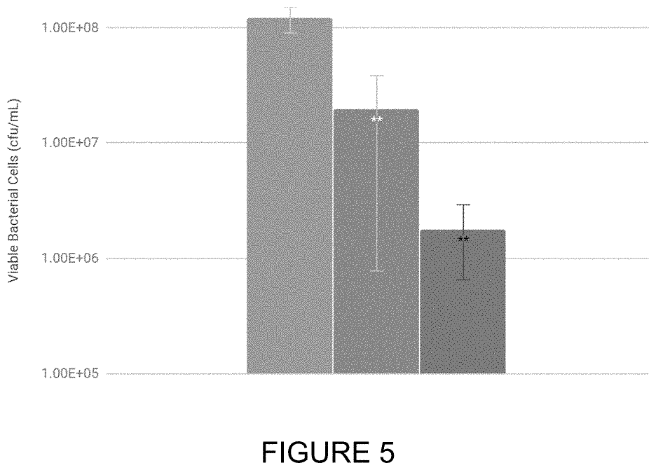

A small section of industrially-conditioned tubing that had been previously used to facilitate S. aureus growth was cleaned (soaked in 10% bleach, scrubbed with water and detergent), re-sterilized, and used in a new static biofilm assay. This process was repeated a total of four times. A decreased inhibition of biofilm growth upon reuse was used, and this effect became more pronounced as the process was repeated. This data suggests that the tubing itself had taken on an antimicrobial effect imparted by the contact with beer, but that this effect was reversible over time and with repeated cleaning and sterilization. To further test this, biofilm growth was examined using a second testing series with a new batch of tubing that had been conditioned with beer. Given the previous observation that the effect of the conditioning can decrease with repeated use, all assays were conducted on the second set of tubing that was sterilized and inoculated only once. The second set of industry tubing had been in constant use for nearly double the length of the first, and consequently had been exposed to an estimated 6.5× larger quantity of beer than the first set (estimated 37K gallons and 240K gallons, respectively). Consistent with previous observations, when compared to inhibition in the first set, an even greater level of inhibition of biofilm growth in the second conditioned (16% and 1% growth relative to controls, respectively) set was observed (p=1.54×10⁻⁷, FIG. 5).

This data strongly suggests that a component of beer is acting on the tubing (e.g. coating the surface, impregnating the plastic) to promote the observed inhibition. This also supports that re-use of tubing serves to mediate this inhibitory effect and that the inhibitory compounds are reversibly bound to the tubing.

To test the generality of the inhibition on other bacterial isolates, bacteria that are more relevant to brewing were used, specifically Lactobacillus brevis and Lactobacillus sakei. The former was selected due to its known ability to infect and spoil beer, as well as its purported ability to proliferate well in the presence of highly hopped material while the latter was selected as a convenient representative Lactobacillus that does not contain genes HorA, HorB and HorC, which confer hop resistance, and is thus sensitive to inhibitory effects from bioactive compounds in the hop oils.

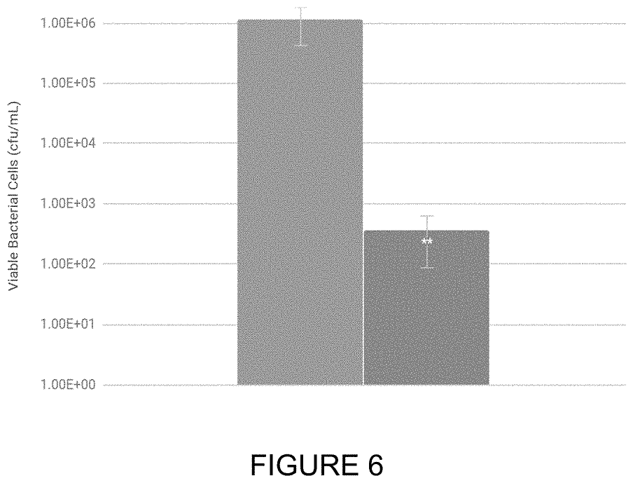

The data obtained with L. sakei followed a similar trend with that observed from S. aureus. When cultured in new and industry tubing, a pronounced inhibition of viable biofilm growth was observed in the industry tubing (FIG. 6) relative to the control.

Despite a larger error within this set of data, the two sets are still statistically significant from one another (p=4.24×10⁻⁴). L. sakei in general grew very slowly (72 hour growth cycles) and did not form as robust of biofilms overall as S. aureus. (FIG. 6, p=0.002). S aureus was reduced by 98% relative to untreated controls when grown in industry tubing and L. sakei was reduced by 99.5% relative to controls when grown in industry tubing. This reduction implies that these two microbes are equally susceptible to the antimicrobial properties within the tubing.

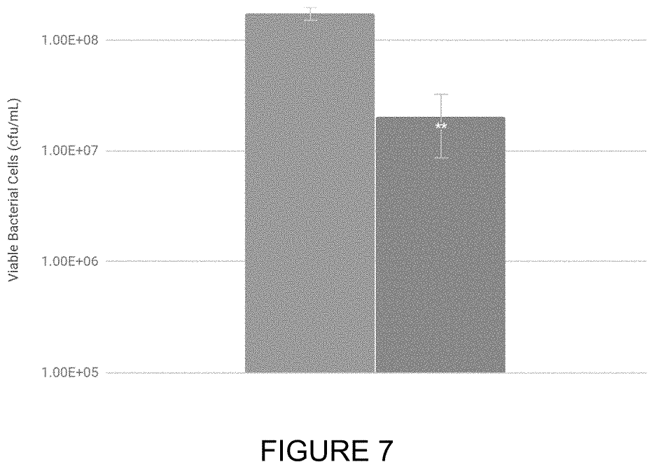

L. brevis followed a similar trend to the previous observations in L. sakei and S. aureus. As seen previously, when cultured in new and industry tubing, there was an observed inhibition in biofilm formation (88% reduction, FIG. 7, p=8.56×10⁻¹²).

Although L. brevis was inhibited by the industrial tubing, it was not inhibited as greatly as S. aureus and L. sakei. However L. brevis' cell density was still reduced by 88% relative to controls.

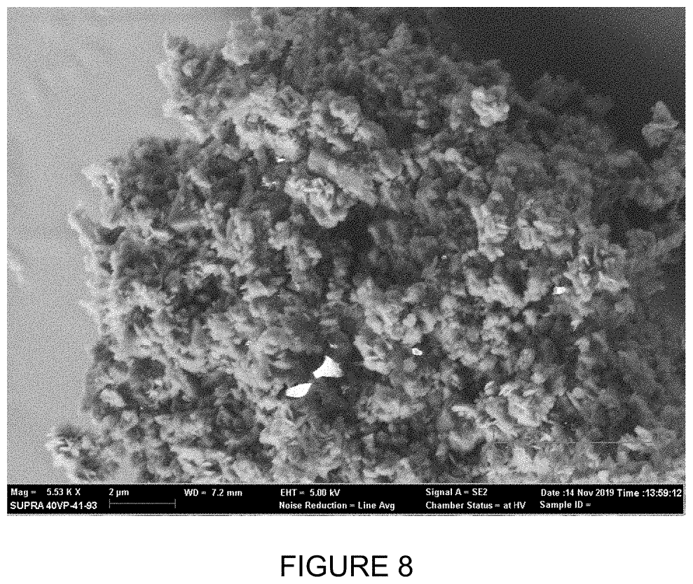

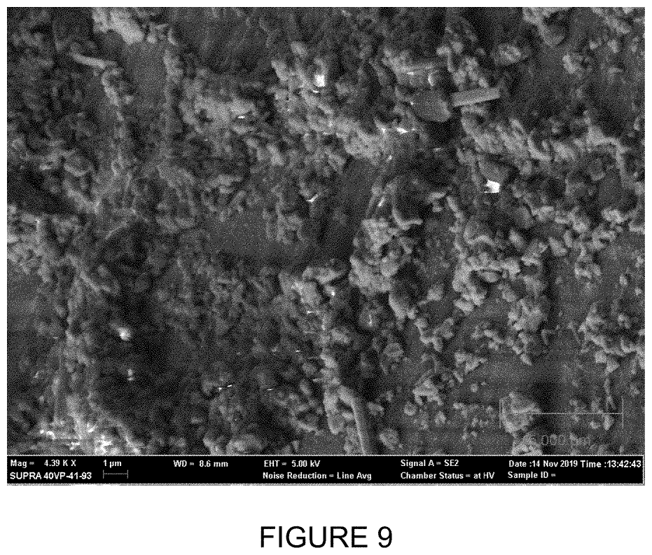

To confirm biofilm adhesion to the surface of the tubing, two SEM images were taken of L. brevis in new and industrial tubing. It can be seen that biofilm formed and spread readily across the interior of the new tubing (FIG. 8) and that biofilm similarly formed in industrial tubing (FIG. 9).

After statistical analysis on all repeated samples, the data demonstrates that the developed assay is an effective means to assess biofilm growth in tubing. Regardless of the tubing used in the examples provided herein (e.g. new vs industry conditioned) the same approximate reduction in viable cells with additional washes was observed. This suggests that inhibition of these bacteria may not only be occurring on the surface of the tubing, but may also be occurring within the media in the tubing during bacterial proliferation. In addition, this data strongly suggests that despite an increase in deposits and physical imperfections introduced into the lines with use, exposure to beer imparts an inhibitory component to the tubing. This is contrary to generally accepted standards in the brewing industry. The observed inhibitory effect is observed to be more pronounced in tubing that has been exposed to an increased usage and quantity of beer, and is observed to exert an effect even on known hop resistant beer spoilage organisms. Over time, the observed inhibition of the conditioned tubing becomes less pronounced. Analyzing the percent reductions in each microbe, it can be inferred that a component of the beer is imparting the observed antimicrobial activity. L. brevis' ability to persist and not respond to the proposed inhibition supports this theory based on L. brevis' increased growth abilities in beer. In order to further investigate the origin of these inhibitory components, tubing was used that had been artificially conditioned in the laboratory with solutions of various types of beer and solutions designed to model beer.

Processes were performed to verify that the observed difference in biofilm colonization effectiveness between new and conditioned tubing is truly from exposure to beer as opposed to another industry-specific process. Furthermore, experiments to identify the materials in beer that are most likely contributing to the observed microbial inhibition in the lines were also performed. A mechanism to replicate the prolonged exposure of draught lines to beer was devised and new tubing (such as Fisherbrand™ Tygon S3™ E-3603) was artificially conditioned in the lab with beer B and beer A. Conditioning independent sets of lines with these two beers were undertaken for a number of reasons. First, these two products comprised the majority of the beer to which the industry tubing had been exposed. Second, the use of these products provide a convenient means to condition draught lines with a beer that is heavily hopped (beer B) as well as one that is hopped at a much lower concentration (beer A), but do not differ substantially in their other components. Specifically, the final pH of both products is similar (4.0-4.2), the yeast strains used in fermentation are similar (Brewing Science Institute, BSI-001® and BSI-011®), and the malt bill uses the same base malts from the same source (2-Row Malt, Great Western Malt Company). Beer B has a higher final ethanol concentration than beer A (7.2% and 4.3%, respectively).

### Example 7: Determining Source of Antimicrobial Inhibition

Further assays for determining the source of antimicrobial inhibitors were performed. In these tests an aqueous extract of hop pellets (weight of hops per volume of beer), in a phosphate buffer with 4.7% ethanol was used to condition lines in order to determine if the hop extract will also induce a comparable antimicrobial effect on the tubing to that found in the industry tests.

Industry conditioned PVC tubing was cut into short (17″) lengths, wrapped with aluminum foil on both ends, and sterilized via autoclave. All tubing was allowed to cool for at least 15 minutes before use. Similar treatments with new PVC tubing were performed to serve as experimental controls.

A 2 L recirculating pump (RM6 Lauda/Brinkman) was used for all conditioning experiments, and all work occurred at 4° C. in a cold room. PVC tubing (Fisherbrand™ Tygon S3™ E-3603) was used in all experiments. Prior to use, the tubing and pump reservoir were sanitized using a no-rinse phosphoric acid based solution (StarSan, Five Star Chemicals) solution. A section of tubing (3.89 m) was cut and affixed to both the inlet and outlet ports of the recirculating pump, and secured with clamps. Approximately 3.8 L of beer or extract solution was added to the pump reservoir, and recirculation was initiated at a flow rate of 1 L/min. The recirculation was allowed to proceed for a total of 7 days (168 hours), after which time the tubing was rinsed with sterile water (1 L) to remove residual beer, autoclaved, and used directly in biofilm experiments. The pH of the recirculated solution was monitored at the start, and end, of the conditioning to confirm that no bacterial contamination had occurred during the experiment.

A 0.1 M phosphate buffer was made by adding 7.84 g of KH₂PO₄ and 1.22 g of K₂HPO₄ into 3.5 L of nano-pure water. To this solution, 184 mL of 95% ethanol was added to create a final concentration of 4.7% ethanol. The pH of the solution was adjusted to 5 with the dropwise addition of concentrated phosphoric acid (14.8 M). This buffer solution was used as the base for further experiments for conditioning with extracts and/or dissolved compounds or mixtures of compounds.

To approximate the concentration of hop materials, the dry hopping conditions used in formulation of this beer were replicated by adding hop pellets (Yakima Chief Hops™ Hop Farm) directly to the base solution. Specifically, Citra hops and Simcoe hops were added to 3.5 L of the base solution at the same approximate amount and ratio as that used in the formulation of beer B and the solution was allowed to rest at 25° C. for 96 hours. After this time, the solution was centrifuged for 30 minutes at 3,000 rpm at 0° C. to remove solid hop material. After centrifugation, the solution was decanted away from any solid material and filtered under vacuum through a Pyrex fritted funnel to remove any residual plant matter. After removal of solid material, the solution was added to the sanitized recirculating pump and used in the conditioning step.

A second dry hop conditioning solution was made to contain approximately ten fold higher amounts of hop pellets (Yakima Chief Hops™) than those used in the initial dry-hop replica solution, but still maintaining the same ratio found in beer B. Citra and Simcoe hops were added to 3.5 L of the base solution and the solution was allowed to rest at 25° C. for 96 hours. After this time, the solution was centrifuged for 30 minutes at 3,000 rpm at 0° C. to remove residual solid hop material. After centrifugation, the solution was decanted away from any solid material and filtered under vacuum through a Pyrex fritted funnel. After removal of solid material, the solution was added to the sanitized recirculating pump and used in the conditioning step.

All inoculations with L. brevis were performed as described in Example 5. Tubing was sterilized, 10 mL of MRS media was inoculated with 20 μL of stock culture and the inoculated tubing was pipetted into the tubing. The tubing was incubated for 24 hours and the tubing was then rinsed and biofilms disrupted with sonication as previously described. The media was subjected to six, ten-fold serial dilutions, plated onto a solid MRS agar medium and incubated for 24 hours. Viable colonies that emerged after this incubation were enumerated.

All inoculations with L. sakei were done as described in Example 4. Tubing was sterilized, 10 mL of MRS media was inoculated with 20 μL of stock culture and the inoculated tubing was pipetted into the tubing. The tubing was incubated for 72 hours and the tubings were then rinsed and biofilms disrupted with sonication as previously described. The media was subjected to six, ten-fold serial dilutions, plated onto a solid MRS agar medium and incubated for 24 hours. Viable colonies that emerged after this incubation were enumerated.

The two beers selected were chosen as conditioning solutions for their general similarities in recipe, their variance in concentration of hops and they comprised the majority of the beer to which the industry tubing provided had been exposed. The tubing was artificially conditioned on the recirculating pump for one week to represent roughly half (total gallons recirculated) the conditioning of the industrial tubing. After one week of recirculation (1 L/min), an estimated 16,000 gallons had recirculated through the tubing.

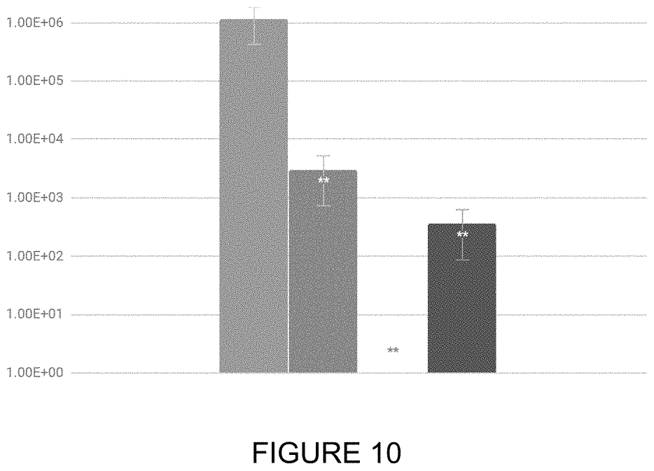

Both species of Lactobacillus were grown in tubing conditioned with two industry beers (beer A and beer B). L. sakei growth was observed to be inhibited in beer A conditioned tubing and in industry-conditioned tubing to approximately the same amount. Lab conditioning of beer B tubing yielded no growth. Both beer A and beer B were determined to be statistically significant from new tubing. In each case, the biofilms found in the conditioned tubing were approximately two orders of magnitude less dense than those found in new tubing (99% reduction relative to controls). No biofilm formation in beer B conditioned lines was observed at all (FIG. 10), which may be due to the increased number of hops used in this beer relative to beer A.

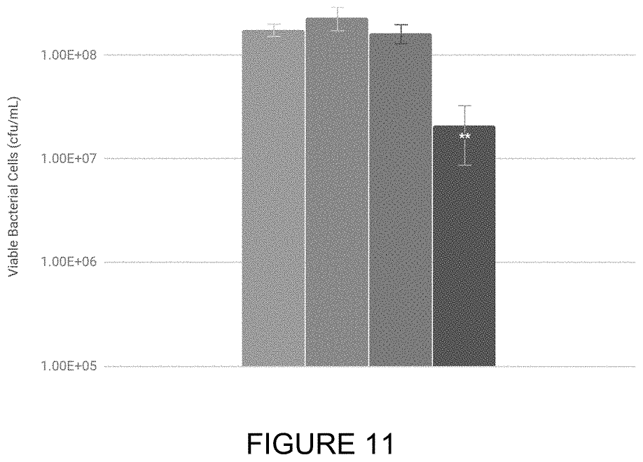

It is not immediately clear why this organism is completely inhibited by conditioning with beer B but does retain some ability to grow in industrially conditioned tubing. It is possible that this organism (which generally grew poorly and to a low density in this assay) may be uniquely sensitive to some component found in higher concentrations in beer B. In contrast to L. sakei, L. brevis in new, beer A and beer B conditioned tubing was observed to grow to similar densities and were not determined to be statistically different from one another (p=0.38, FIG. 11). No growth inhibition was observed for beer A or beer B conditioned tubing.

L. brevis is known to be insensitive to some concentrations of hop compounds, and the difference in the artificial vs industry conditioned lines likely reflects variance in the amount of these compounds in which the two sets of lines were exposed. The in-house conditioning test is unable to completely replicate the exact conditions, nor the amount of flowing solution found in actual industrial use. The artificially conditioned tubing was conditioned by circulating the same gallon of beer as opposed to new beer at all times in the industry conditioned tubing.

The data suggests that L. brevis' purported resistance to the antimicrobial activity of hops is the likely reason that little inhibition is observed in artificially conditioned tubes relative to new tubes. As discussed above, the MIC of most hop-resistant isolates of Lactobacillus spp. to a supercritical hop extract was determined to be approximately twenty times greater than that of a sensitive Lactobacillus strain.

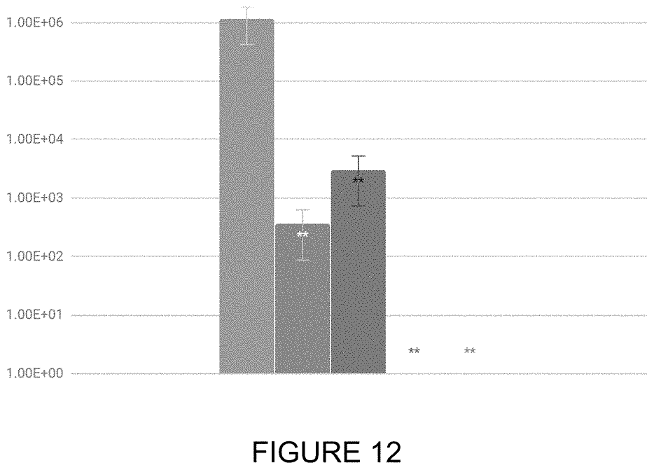

A base solution of 4.7% ethanol in phosphate buffer (pH=5) was used to extract hop oils in a manner that was designed to parallel a typical “dry-hop” addition in the brewing process. “Dry Hopping” beer refers to adding hop pellets directly to the fermentation vessel as opposed to during the boil. This allows for the extraction of small compounds that are typically lost during the boil due to their volatility. It also helps mediate the isomerization of α and β-acids within the lupulin glands. This is useful in this case because it is effectively a cold extract. As discussed above, many of these compounds are volatile. Extracting the compounds cold minimizes the risk of evaporation. The amount and type of hops used was representative of a dry hopping regime of beer B. Replication of the dry-hop regimen in the lab provided a means to test the antimicrobial activity of the extracted hop components, particularly the volatile compounds, in the absence of the other complicating factors in beer that were derived from barley and yeast. When L. sakei was grown in the tubing conditioned in this manner, growth inhibition was observed relative to growth in untreated lines (99.7% reduction), but was generally comparable to that observed in industry conditioned tubing (FIG. 12, p=4.32×10⁻⁴). Due to standard deviation, industry, dry hop and beer B were deemed statistically significant.

As previously observed with S. aureus in industry conditioned lines, an increased exposure of the tubing to a greater volume of beer resulted in a more pronounced inhibition of bacterial growth in the lines. To test if this phenomenon could be replicated in a laboratory setting, tubing was conditioned with a second “dry-hop” solution wherein the mass of extracted hops was roughly 10 times that used in the first experiment. L. sakei was unable to form biofilms in the lines conditioned with this concentrated hop extract (FIG. 12).

### Example 8: Lactobacillus brevis Growth in Tubing Conditioned with a Hop Extract

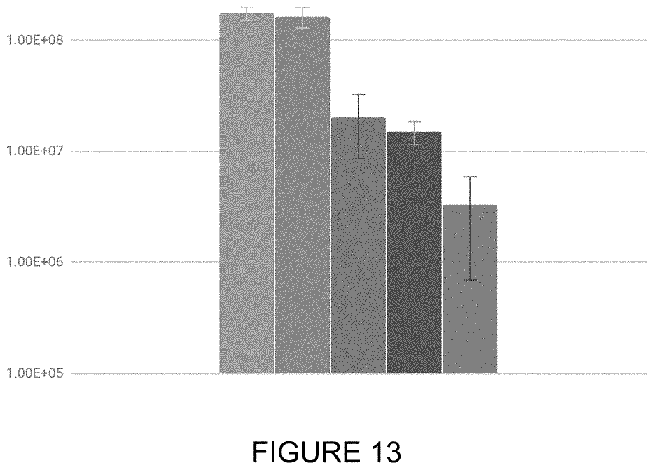

The dry-hop conditioned tubing was also used in biofilm experiments with L. brevis. Similar to that observed for L. sakei, L. brevis biofilms were also inhibited when grown in beer B and dry-hop conditioned tubing relative to new lines. The dry-hop tubing showed less viable bacteria relative to the beer B conditioned tubing (90% reduction of beer B relative to dry hop, FIG. 13). Dry hop conditioned tubing had a similar inhibitory effect on biofilm formation of L. brevis compared to industry tubing.

The data observed in the biofilm colonization ability of both of these strains grown in dry-hop conditioned lines indicates that the inhibitory factors in beer significantly originate from hop oils. Much like that observed for L. sakei, dry-hop conditioned tubing and the industry conditioned tubing sets in L. brevis biofilm experiments were not significantly different from one another, which suggests that the inhibitory factors in both conditioning solutions likely originate from the same biological material. Notably, when L. brevis was grown in tubing conditioned with the concentrated (10×) hop extract, a more pronounced reduction in biofilm growth relative to new lines was observed, even though the strain in use is recognized as a “hop resistant” isolate. Although L. brevis is recognized as having a heightened resistance to the oils within hops, eventually the concentration of any given compound will exceed the organism's ability to avoid its effect. After the concentration exceeds an organism's resistance threshold, cell proliferation will be slowed and ultimately ceased. The reason that L. brevis is inhibited more by the concentrated hop extract when compared to industry tubing is likely because the concentration of antimicrobial compounds within hops is higher than that of the beers in industry. Additionally, the growth of L. brevis in these tubing was lower than that observed in industry conditioned tubing (84% reduction of concentrated dry hop relative to industry tubing, FIG. 13).

### Example 9: Antimicrobial Coatings for Common PVC Tubing

Specific compounds that influence biofilm colonization effectiveness between new and conditioned tubing were explored, as well as methods capable of effectively depositing them onto the surface of synthetic beverage tubing. Specifically, individual chemical compounds or mixtures of components were used to condition tubing to exert an antimicrobial effect. These materials are likely exerting their antimicrobial effect through permeation, sorption and desorption into and out of the tubing. Myrcene, farnesene, linalool, geraniol, geranic and citronellic acids were used to condition tubing to test their ability to permeate into the tubing and subsequently inhibit microbial growth, and the concentration and exposure duration required to exert this effect were also assessed.

New tubing (Fisherbrand™ Tygon S3™ E-3603 Flexible Tubing, Fisher Scientific #14-171-132) was cut into short (17″) lengths. A barb-to-barb (Two prong male/male barb fitting, 5/16″) fitting was inserted into one end of the tube, each end of the tube was wrapped with aluminum foil and sterilized via autoclave. All tubing was allowed to cool for at least 15 minutes before use. Equal volumes (2 mL) of myrcene, geraniol, linalool, geranic acid and citronellic acid were added to the sterile tubing. Each end of the tubing was then connected together via the barb fitting. The loop was placed flat and level on a table top shaker incubator and left shaking overnight (18 hours) at 200 rpm at 20° C. After this time the neat reagents were removed and the tubing was rinsed with sterile water (0.5 L) to remove all residual material.

The procedure as described previously was followed. Tubing was sterilized and equal volumes (5 mL) of citronellic and geranic acids were added to the tubing. The tubing was left shaking overnight (18 hours). The neat chemicals were removed and the tubing was rinsed with sterile water (0.5 L) to remove residual material.

To condition tubing, 5 mL of neat geranic acid and 5 mL of neat citronellic acid were placed into 17″ of factory new tubing. Another tube was taken and 10 mL of neat hexane was added. The acids and hexane were left inside the tubing for 24 hours. A small section of the tubing was cut from the center of the line, and was further divided into four equal parts to expose the inside of the tubing. The tubing was placed on stubs using double sided carbon tape and coated with a gold/palladium alloy using a Denton Vacuum Desk II for ten seconds to ensure that the small structures would remain visible. At this time, samples were imaged on a Zeiss Supra 40VP at 68× magnification and a varying power level of 3 to 5 kV.

PVC tubing was cut into short (17″) lengths. Each end of the tubing was then connected together via the barb fitting. This was placed flat and level on a table top shaker incubator and sterilized via autoclave. All tubing was allowed to cool for at least 15 minutes before use. Equal volumes of geranic acid and citronellic acid were added to the sterile tubing, formed into a closed loop with barb fit, and was placed flat on a table top shaker incubator. The loop was allowed to shake overnight (18 hours) at 200 rpm at 20° C. The neat chemicals were then removed and the tubing was rinsed with sterile water according to standard recommended practices. Specifically, the rinse of chemicals from brewing equipment is recommended to be accomplished by one or more short bursts of fresh water. To imitate this procedure in the lab, 140 mL of sterile water at 83° C. was rinsed through the tubing in seven equal rinses of 20 mL each. After the water rinses, 20 mL of MRS media was then added to the tubing and incubated without shaking at 23° C. for 24 hours, at which time the pH of the media was recorded. After pH measurement, the media was placed into a 15 mL falcon tube and inoculated with 20 μL of confluent L. brevis. The inoculated tube was incubated for 24 hours at 37° C. in a shaker incubator at 225 rpm, at which time bacterial viability was assessed through streak plating on MRS agar. This process was repeated daily until observable growth was noted on the solid medium. Once growth was observed on the plate, 10 mL of MRS was inoculated with 20 μL of L. brevis stock culture. This 10 mL of inoculated MRS was then put into the tube and was incubated for 24 hours at 37° C. The tubing was then diluted, plated and enumerated as described above.

Citronellic and geranic acids were added to one liter of the base buffer solution at their maximum soluble concentrations (1.74 g/L and 1.22 g/L, respectively). New tubing (Fisherbrand™ Tygon S3™ E-3603 Flexible Tubing, Fisher Scientific #14-171-132) cut into short (17″) lengths. A barb-to-barb fitting was inserted into one end of the tube, each end of the tube was wrapped with aluminum foil and sterilized via autoclave. All tubing was allowed to cool for at least 15 minutes before use. The solution was then added to the tubing. Each end of the tubing was then connected together via the barb fitting. This was placed flat and level on a table top shaker incubator and left shaking overnight (18 hours) at 200 rpm at 20° C. The neat chemicals were removed and the tubing was rinsed with sterile water (0.5 L) to remove all residual material. To rinse the tubing, 140 mL of sterile water at 83° C. was flushed through the tubing in seven equal rinses of 20 mL each. After the water rinses, 10 mL of MRS media was inoculated with 20 μL of L. brevis stock culture, which was subsequently introduced into the individually cut lengths of tubing. These tubes were then incubated in a static incubator at 37° C. for 24 hours. The procedure was repeated for enumeration and plating.

Citronellic and geranic acids were added to one liter of buffer solutions at a concentration of 10 times their maximum aqueous solubilities (17.4 g/L and 12.2 g/L, respectively). New tubing was taken and sterilized via autoclave. The solution was shaken, by hand, until it was entirely dispersed into an oil-in-water emulsion (visually opaque) and was subsequently placed (10 mL per 17″) into the sterile tubing, closed into a loop and shaken on a table top shaker incubator at 200 rpm at 20° C. Sections of tubing were conditioned for 20 minutes, 60 minutes and 24 hours, respectively. After conditioning, 140 mL of sterile water at 83° C. was rinsed through the tubing in seven equal rinses of 20 mL each. After the water rinses, 10 mL of MRS media was inoculated with 20 μL of L. brevis stock culture, followed by dilution and enumeration of viable cultures.

The base buffer solution was used to dissolve citronellic and geranic acids. Citronellic and geranic acids were added to one liter of buffer solutions at a rate of 10 times their maximum soluble concentrations (17.4 g/L and 12.2 g/L, respectively). Myrcene, farnesene, linalool and geraniol were also added to this solution at their solubility concentrations (4.09 mg/L, 3.38 mg/L, 1.59 g/L and 100 mg/L, respectively). New tubing was taken and sterilized via autoclave. The solution was agitated until an emulsion was visible at which time it was added to the sterile tubing. The tubing was placed on a table top shaker incubator and left shaking at three different time intervals at 200 rpm at 20° C. Sections of tubing were conditioned for 20 minutes, 60 minutes and 24 hours. After conditioning, 140 mL of sterile water at 83° C. was rinsed through the tubing in seven equal rinses of 20 mL each. After the water rinses, 10 mL of MRS media was inoculated with 20 μL of L. brevis stock culture. The procedure described above was repeated for dilution and enumeration of viable cultures.

A preliminary test to condition tubing with individual terpene components was conducted to ascertain which compounds found in hops are likely to play an antimicrobial effect in the embodiments provided herein. Three individual lengths (n=2) of tubing were sterilized and conditioned with neat compounds. One section was exposed to a mixture of terpene hydrocarbons and terpene alcohols (myrcene, farnesene, linalool and geraniol) and terpene acids (geranic and citronellic acids). The other two sections were conditioned with mixtures containing individual classes of each of these groups of compounds (e.g. terpene hydrocarbons/alcohols or terpene acids, respectively). One tubing was conditioned with terpene hydrocarbons and alcohols (myrcene, farnesene, linalool and geraniol) and the other tubing was conditioned with the terpene acids (geranic and citronellic acid). No growth was observed in tubing conditioned (for 24 hours) with the mixture of terpene hydrocarbons, alcohols and acids (0 CFU/mL). Similarly, no growth was observed in tubing conditioned with terpene acids alone (0 CFU/mL). On the contrary, tubing conditioned exclusively with a mixture of terpene hydrocarbons and alcohols alone was observed to exhibit statistically insignificant reductions in biofilm growth relative to unconditioned tubing (1.5×10⁸ CFU/mL). Consequently, antimicrobial action of tubing conditioned with the terpenoid acids was selected.

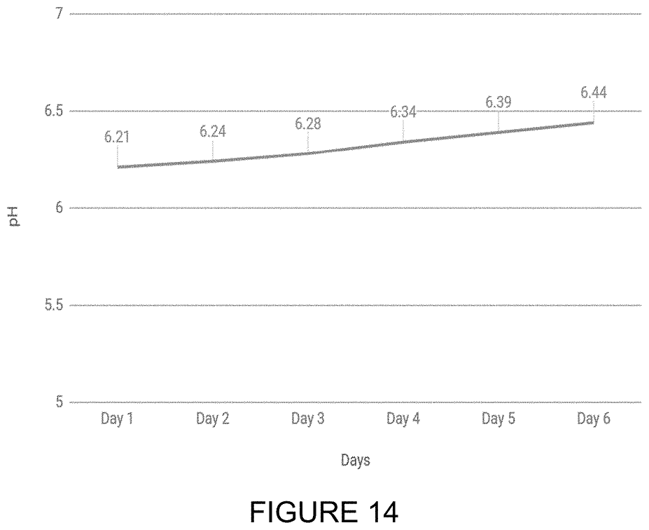

After the tubing was conditioned with neat acids and washed with hot water (following a best practice in the brewing industry), pure MRS media was introduced into the tubing. After 24 hours of incubation, a significant amount of organic material desorption from the tubing was noted as a biphasic layer at the aqueous interface of each end of the tubing. Despite inoculation with an active culture of L. brevis, no microbial growth was observable in this media after a 24 hour incubation. Furthermore, the pH in this medium was lower than that of the original media (6.21 and 6.71, respectively). This process was repeated daily and the pH was observed to incrementally rise after each incubation (FIG. 14).

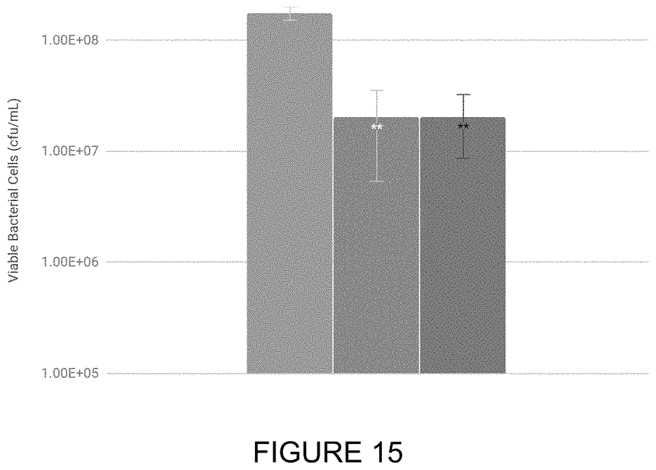

Each daily inoculation of L. brevis was streaked onto MRS media to assess raw bacterial viability in the solution. This was repeated for six days. No microbial growth was observed for four subsequent incubations with only minor viability observed after a fifth incubation. A full assessment of biofilm adherence onto the tubing was conducted on the sixth day, as herein. The tubing was inoculated, washed, sonicated and enumerated. After six days of washing using industry best practices and microbial culture, L. brevis was observed to be inhibited to a similar extent to that commonly observed in tubing that had been previously used in industry (88%, FIG. 15). After six days of media soaking, the acid tubing inhibited similarly to that of industry tubing. (n=9 for industry and new tubing, n=2 for neat acids). This indicates that geranic and citronellic acids are capable of permeating into the tubing and inhibiting biofilm formation, and that the conditioning of tubing with neat formulations may exert a prolonged antimicrobial effect.

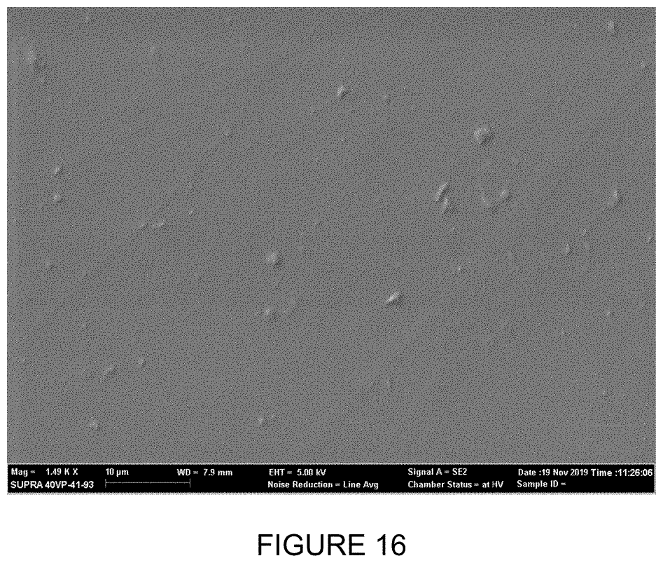

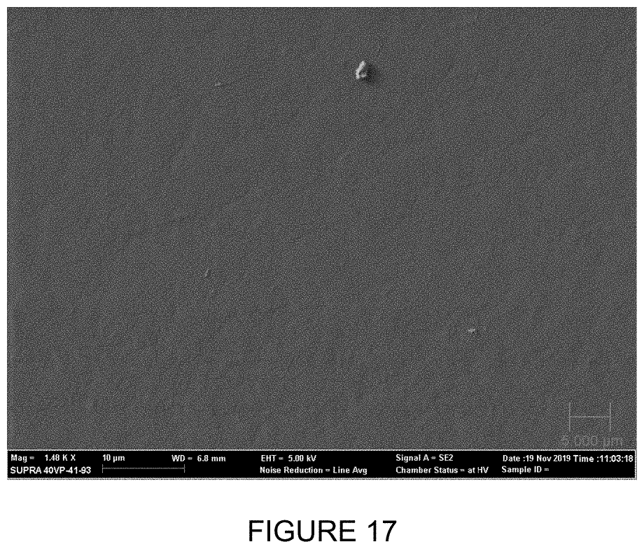

To confirm that the tubing had not been physically affected by the neat chemical treatments, two sections of tubing were conditioned. In this test, tubing was treated with neat chemicals (geranic acid, citronellic acid and hexane) in order to observe the tubing using SEM technology to assess how neat chemical treatments affected the physical properties of the tubing. One tubing was conditioned with neat geranic and citronellic acids and the other was treated with neat hexane, and compared to images of untreated new tubing. In each tubing, no physical abnormalities were observed (FIGS. 16 and 17).

### Example 9: Tube Conditioning and Inoculation

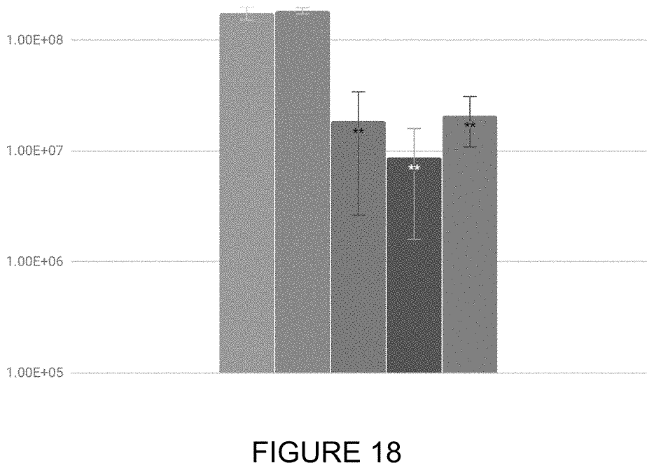

After determining that the isoprenoid acids were capable of exerting an antibacterial effect, an assay for conditioning tubing and inoculating was developed. Tubing was first sterilized via autoclave followed by chemical conditioning as described herein in order to preclude any “loss” of inhibition as seen in re-used industry tubing. After sterilization, tubing was conditioned with a phosphate buffer solution (˜5% ethanol) containing geranic and citronellic acid at their predicted aqueous solubilities. Following the conditioning, L. brevis was inoculated into the tubing following the procedures described herein. At this concentration, however, no inhibition was observed. To assess if contact of the tubing with neat chemicals was essential to the antimicrobial effect, the tubing was treated with an oil-in-water emulsion of the reagents in question. To affect this emulsion, a buffer containing geranic and citronellic acids at a concentration of ten times that of their solubility was constructed. This solution was then used to condition the tubing and after washing and inoculation of L. brevis, inhibition of biofilm adherence was observed (FIG. 18).

The length of time required for the tubing to be exposed to this active concentration in order to observe an antibacterial effect was also investigated. Tubing was conditioned at a fixed concentration of organic material (17.4 g/L citronellic acid and 12.2 g/L geranic acid) at varying time intervals (20 minutes, 60 minutes, and 24 hours). After conditioning and inoculation, L. brevis was observed to be inhibited by this conditioning (at 24 hours, 88%, p=5.76×10⁻¹², FIG. 18). The positive control and new tubing were deemed insignificant from each other.

In this example, the time the conditioning solution came into contact with the tubing was not observed to have a substantial effect on inhibition of bacterial adherence. Permeability, sorption and desorption vary depending on the organic solvent. In this case, the solvents remained the same, and although conditioning time was varied, inhibition of bacterial growth did not change. This suggests that the antibacterial effect imparted by the conditioning happens rapidly when oil-in-water emulsions of the active compounds contact the beverage tubing.

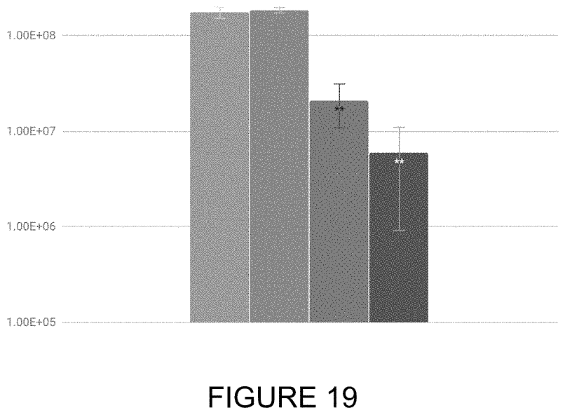

A secondary set of testing was performed to ascertain if the terpenes compounds associated with hops have any additional inhibitory effect in the presence of the isoprenoid acids (FIG. 19). Surprisingly, after 24 hours of conditioning with additional known antimicrobial components, no additional inhibition was observed. Both 24 hour conditionings were determined to be significant to new tubing, but were insignificant to each other.

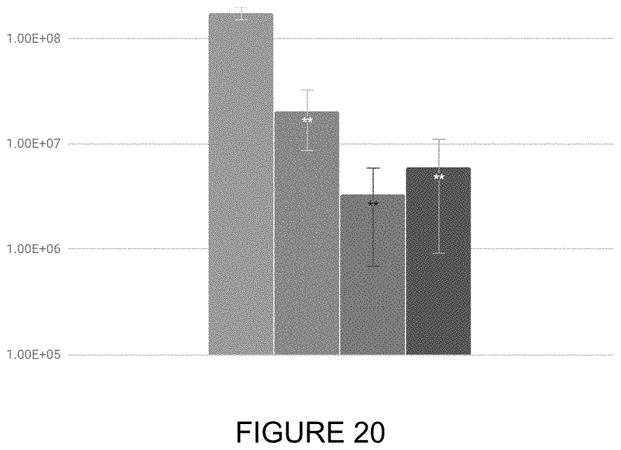

Many compounds within the lupulin glands of hops are known to have antimicrobial properties, and many of those compounds are significantly hydrophobic. Consequently there is a strong likelihood that these materials have a significant affinity for PVC tubing and may readily absorb and permeate into this material. In raw hop extracts, the synergistic effect of all existing antimicrobial compounds is likely the source of the antibiofilm effect observed in the industrial tubing. The data presented herein strongly suggests that the acids permeate into the tubing and potentially desorb into the media, enacting an inhibitory effect on L. brevis. When comparing cell densities of L. brevis cultured in industry and tubing conditioned with neat acids, a similar inhibition is observed (FIG. 15). When comparing the concentration of acid to observed inhibition, there is a correlation of higher concentration to a greater observed inhibition. When neat acids were used no growth was observed and when tubing was conditioned by acids at their solubility concentration no inhibition was observed. After using a higher concentration of acid to condition tubing, growth was once again observed to be inhibited (FIG. 16). Concentration showed the only effect on inhibition, and when conditioning times were varied no statistical change in cell density was observed. When comparing industry, concentrated dry hop and 24-hour acid and terpene conditioned tubing, inhibition is again correlated to concentration of compounds within solution (FIG. 20). The data obtained in these examples unexpectedly indicates that sorption of these organic acids has an inhibitory effect on L. brevis. Concentration of antimicrobial compounds correlates to inhibition observed.

### Example 10: Further Antimicrobial Inhibition Studies

This example demonstrates the antimicrobial and/or antibiofilm properties of formulations comprising hops extracts. Beers used include beer B (70 IBU) and beer A (19 IBU).

Biofilm viability measurements in tubing that was artificially conditioned with aqueous extracts of the hops found in beer B were performed. The extracts were generated by replicating the “boil” process within the process of brewing beer B, but water was used as the extractant in place of wort, as the recipe otherwise directs. Biofilm growth was suppressed by the pretreatment relative to untreated lines. Biofilm viability measurements in tubing that was artificially conditioned with 5% ethanol in water unheated extracts of beer B hops was performed. This step was done to replicate the process of “dry hopping” (which is performed in the process of brewing beer B). Dry hopping is a means to extract hop compounds in the absence of heat which in turn prevents evaporation of volatile flavorings. Extracts were made to replicate the concentration of hops used in beer B as well as extracts representing ten times higher concentrations. All pretreatments served to reduce the ability of bacterial biofilms to form relative to untreated lines. Biofilm viability measurements over time on pretreated lines were systematically reused. It was observed that the ability of biofilms to grow and nucleate in the pretreated lines is facilitated as the lines are repeatedly cleaned and reused. This shows that the modification of the lines by the treatment solution is not irreversible.

In lines treated with the novel formulations, no appreciable populations had been observable. Deliberate attempts to grow new biofilms (deliberate microbial contaminants introduced into lines previously used in beer transfer) in used lines was far less successful than growth in unused new lines.

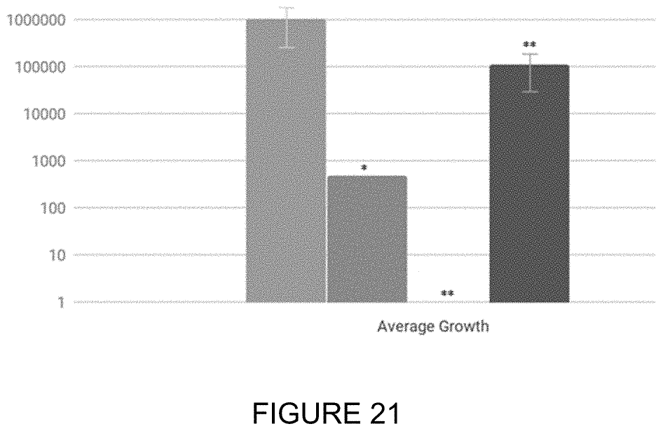

Lactobacillus sakei growth in factory-new tubing, industry-conditioned tubing, 10× concentrated dry hop-conditioned tubing, and beer B conditioned tubing (left to right columns, respectively) is shown in FIG. 21. No growth was observed in the 10× concentrated dry hop-conditioned tubing. Significance tests were conducted against the factory-new tubing wherein * designates a P-value less than 0.05, and ** designates a P-value less than 0.001.

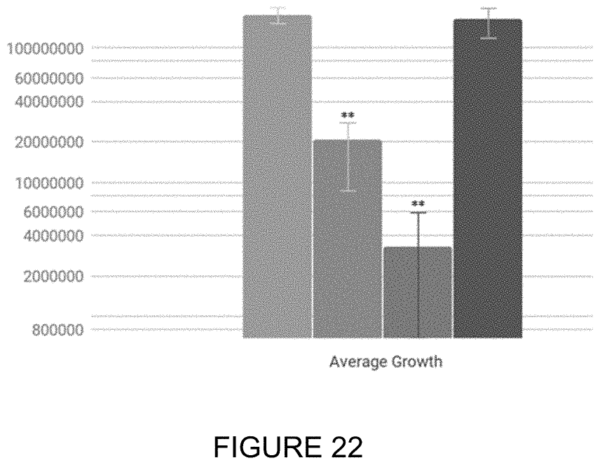

Lactobacillus brevis grown in factory-new tubing, industry-conditioned tubing, 10× dry hop-conditioned tubing, and beer B conditioned tubing (left to right columns, respectively) is shown in FIG. 22. The amount of L. brevis able to grow in the 10× dry hop-conditioned tubing was significantly less than in the factory-new tubing, industry-conditioned tubing and beer B conditioned tubing. Significance tests were conducted against the factory-new tubing wherein * designates a P-value less than 0.05, and ** designates a P-value less than 0.001.

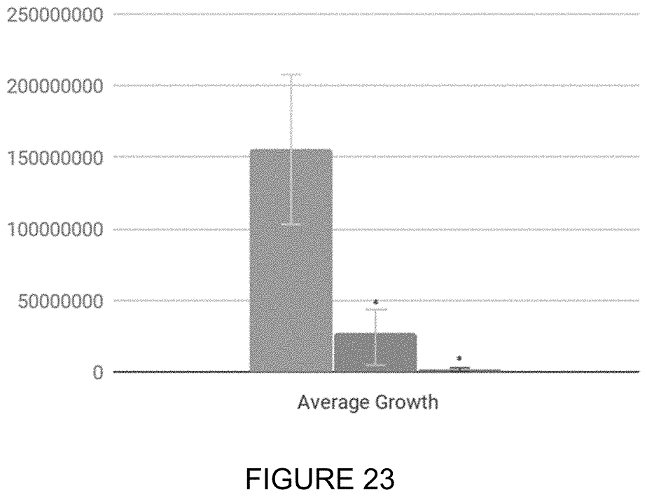

Staphylococcus aureus growth in factory-new tubing (left column), industry-conditioned tubing (middle column—batch 1), and industry-conditioned tubing (right column—batch 2) is shown in FIG. 23.=Batch 1 tubing was used for three months and exposed to approximately 37,000 gallons of beer prior to experimental analysis. Batch 2 tubing was used for six months and exposed to approximately 240,000 gallons of beer prior to experimental analysis. The results show that the amount of bacterial growth in tubing exposed to 37,000 gallons of beer was about six-fold less than factory-new tubing, and the amount of bacterial growth in tubing exposed to 37,000 gallons of beer was extremely low. This illustrates the ability of a hop-containing fermented beverage to inhibit bacterial growth. Significance tests were conducted against the factory-new tubing wherein * designates a P-value less than 0.05.

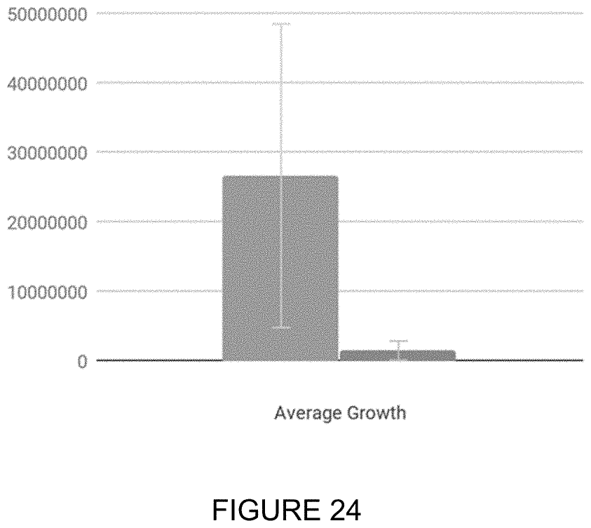

Staphylococcus aureus growth in industry-conditioned tubing (left column—batch 1) and industry-conditioned tubing (right column—batch 2) is shown in FIG. 24. Batch 1 tubing was used for three months and exposed to approximately 37,000 gallons of beer prior to experimental analysis. Batch 2 tubing was used for six months and exposed to approximately 240,000 gallons of beer prior to experimental analysis. The results show that the amount of bacterial growth in tubing exposed to 240,000 gallons of beer was at least 12-fold less than tubing exposed to approximately 37,000 gallons of beer, demonstrating that longer exposure of the tubing to the beer results in better antimicrobial activity.

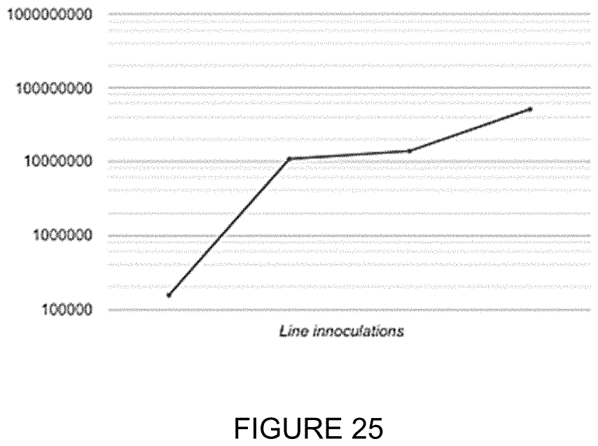

A graph of Staphylococcus aureus grown in reused factory-new tubing is shown in FIG. 25. Each data point represents the average cell growth for that cycle of inoculation.

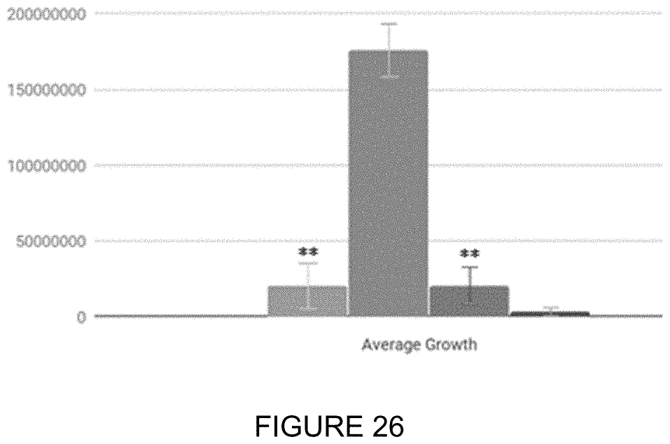

Lactobacillus brevis growth in tubing conditioned with a combination of neat geranic and citronellic acids, factory-new tubing, industry-conditioned tubing, and 10× concentrated dry hop-conditioned tubing (left to right columns, respectively) is shown in FIG. 26. The results show that the amount of bacterial growth in tubing exposed to the neat acids was reduced at least seven-fold compared to factory-new tubing. Significance tests were conducted against the factory-new tubing wherein * designates a P-value less than 0.05, and ** designates a P-value less than 0.001.

Thus, when draught lines are subject to pretreatment with the antimicrobial formulations, microbial colonization is suppressed even though surface imperfections are established. Thus, the chemical agents in the formulations are depositing on the surface of the tubing over time and acting as antibiotics, which then serve to suppress microbial attachment, growth, and establishment.

Although the examples presented herein relate to tubing used in the beverage and brewing industries, similar effects are expected to occur in tubing used in the medical field, as many of these tubings are made of the same materials as those in the beverage and brewing industries, and the ability of the formulations described herein to exert an antimicrobial and or antibiofilm effect on any such tubing, medical device, medical instrument, dental instrument, or any other surface can be easily determined by one of ordinary skill in the art.

The described features, advantages, and characteristics may be combined in any suitable manner in one or more embodiments. One skilled in the relevant art will recognize that the circuit may be practiced without one or more of the specific features or advantages of a particular embodiment. In other instances, additional features and advantages may be recognized in certain embodiments that may not be present in all embodiments. Reference throughout this specification to “one embodiment,” “an embodiment,” or similar language means that a particular feature, structure, or characteristic described in connection with the embodiment is included in at least one embodiment. Thus appearances of the phrase “in one embodiment,” “in an embodiment,” and similar language throughout this specification may, but do not necessarily, all refer to the same embodiment.

What is claimed is:

1. An antimicrobial and/or antibiofilm formulation, comprising an aqueous solution of at least one compound selected from the group consisting of a terpene, terpene alcohol, and acid obtained from a plant containing such a compound.

2. The formulation of claim 1, wherein the plant is selected from the group consisting of hops, tea, thyme, cannabis, Spanish sage, and citrus fruits.

3. The formulation of claim 1, wherein the terpene is selected from the group consisting of bisabolol, borneol, carene, camphene, caryophyllene, carophyllene oxide, cymene, carvacrol, eugenol, cinnamaldehyde, eucalyptol, farnesene, geraniol, geranyl acetate, humulene, linalool, linalyl isononoate, luparone, luparenol, luparol, limonene, myrcene, menthol, nerol, neral, nerolidol, ocimene, pinene, terpineol, valencene, xantholumol (including methylated, prenylated and geranylated derivatives), isoxanthohumol, myricetin, quercetin, glycosylated quercetin, kaempferol, glycosylated kaempferols, catechin, epicatechin, gallocatechin, afzelechin, epiafzelechin, procyandins B1-B4, proanthocyanidin B3, proanthocyanadine C2, and oxidized product derivatives thereof.

4. The formulation of claim 1, wherein the acid is selected from the group consisting of geranic acid, citronellic acid, humulone, adhumulone, posthumulone, prehumulone, cohumulone, lupulone, colupulone, adlupulone, and a combination thereof.

5. The formulation of claim 1, wherein the solution contains citronellic acid and geranic acid.

6. The formulation of claim 5, wherein a ratio of the citronellic and geranic acid is about 1:1.

7. The formulation of claim 1, wherein a total concentration of the compound is at least about 3%.

8. The formulation of claim 1, wherein the terpene, terpene alcohol, acid, or combination thereof are emulsified.

9. The formulation of claim 1, wherein the aqueous solution is a buffered ethanol solution.

10. The formulation of claim 1, wherein the formulation is used to pretreat a surface to resist microbial colonization.

11. The formulation of claim 9, wherein the formulation does not materially alter or damage the surface.

12. The formulation of claim 9, wherein the formulation leaches off the surface over time.

13. The formulation of claim 11, wherein microbes are removed from the surface as the formulation leaches off the surface over time.

14. The formulation of claim 9, wherein the surface is the surface of plastic tubing.

15. The formulation of claim 13, wherein said plastic tubing is medical tubing or tubing used to carry a beverage.

16. A method of inhibiting or preventing bacterial growth and/or biofilm formation on a surface, comprising contacting the surface with an aqueous solution of at least one compound selected from the group consisting of a terpene, terpene alcohol, and acid obtained from a plant containing such a compound.

17. The method of claim 16, wherein the aqueous solution is emulsified.

18. The method of claim 16, wherein the surface is a surface of plastic tubing.

19. The method of claim 18, wherein the plastic tubing is medical tubing.

20. The method of claim 16, wherein the surface is immersed in, sprayed with, or rinsed with the formulation.
